(19) United States
(12) Patent Application Publication
(10) Pub. No.: US 2026/0073022 A1
(43) Pub. Date: Mar. 12, 2026

(54) Graph Theory-Based System and Method for Quantifying and Visualizing Gan-Zhi Energy Patterns in Multi-Domain Analysis

(71) Applicant: Hanyin Zhang, Las Vegas, NV (US)

(72) Inventor: Hanyin Zhang, Las Vegas, NV (US)

(21) Appl. No.: 18/827,803

(22) Filed: Sep. 8, 2024

(51) Int. Cl. G06F 18/20

(52) U.S. Cl. CPC G06F 18/29

(57) ABSTRACT

This invention presents a graph theory-based system for quantifying and visualizing Gan-Zhi energy patterns in Chinese metaphysics. The system incorporates a coordinate system with wildcards, predefined energy patterns, and graph-based search algorithms for pattern recognition. It features rules for energy attribute modification, customizable pattern priorities, and parallel processing capabilities. The invention provides methods for mapping Gan-Zhi data to Five Elements and Ten Gods systems, along with a six-pillar 3D visualization of relationships. By converting inputs to Gan-Zhi format, building graph models, and generating multi-dimensional visualizations, the system applies modern data analysis techniques to traditional concepts. This approach enhances the scientific rigor of metaphysical analysis, improves data interpretability, and enables new applications in cultural studies, data science, and related fields.

### I. TECHNICAL FIELD

This invention relates to the intersection of traditional Chinese cultural studies and computer science, specifically a Gan-Zhi energy quantification and visualization system based on graph theory. This system combines traditional metaphysics with modern data analysis and graph theory to provide a new methodology and tools for studying spatiotemporal energy states.

### II. BACKGROUND TECHNOLOGY

Metaphysics is an important part of ancient Chinese philosophy, studying the states and changing patterns of spatiotemporal energy. Its core concept—the Gan-Zhi system—originated in ancient China and is a complex and precise spatiotemporal encoding method.

However, current metaphysics research faces the following main problems:
1. Limitations of qualitative descriptions: Traditional texts describe Gan-Zhi energy reactions using qualitative and vague language, lacking precise quantitative standards. This limits its application and development in modern scientific systems.
2. Fragmentation of systems: There are conceptual gaps between metaphysics systems from different periods and schools, lacking a unified theoretical framework and analytical methods. This makes it difficult to effectively integrate and compare research results.
3. Insufficient visualization methods: Traditional metaphysics lacks intuitive, dynamic visualization tools, making it difficult to intuitively present and analyze complex Gan-Zhi relationships and energy changes.
4. Limited interdisciplinary applications: Due to the lack of standardized and quantitative research methods, it is difficult to combine metaphysical principles with modern scientific fields like data science and complex systems theory. This limits its potential for interdisciplinary applications.

Given these issues, there is an urgent need for a research tool that can combine traditional metaphysical principles with modern scientific methods to improve the scientific nature, systematization and application value of metaphysics research. This invention was proposed against this background, aiming to provide an innovative methodology and technical platform for metaphysics research by introducing graph theory, data analysis and visualization techniques.

Comparison with Existing Technology

This invention provides a Gan-Zhi energy quantification and visualization system based on graph theory, with significant innovations and advantages compared to existing technology. Traditional metaphysical analysis mainly relies on personal experience and qualitative descriptions, lacking standardized methodologies and objective quantitative indicators. In contrast, this invention achieves the following breakthrough improvements by introducing modern scientific techniques, especially graph theory and data analysis methods:
1. Systematization and standardization: This invention establishes a complete analytical framework based on graph theory, transforming traditional experiential analysis into repeatable and verifiable standardized processes. This method significantly improves the consistency and reliability of analysis.
2. Quantitative analysis: By introducing quantitative indicators such as energy intensity and stability, this invention enables precise measurement and comparison of previously vague metaphysical concepts. This quantitative method greatly enhances the accuracy and objectivity of analysis.
3. Advanced visualization technology: This invention has developed various innovative visualization methods, such as the six-pillar 3D interactive diagram, five-element disk diagram, and ten-god energy flow dynamic diagram. These advanced visualization tools not only intuitively display complex energy relationships, but can also dynamically present energy flows, greatly enhancing data readability and depth of analysis.
4. Interdisciplinary application potential: By integrating modern data analysis techniques, this invention bridges traditional metaphysics with multiple disciplines such as economics, history, and meteorology, significantly expanding its range of applications. This interdisciplinary approach provides new analytical tools and perspectives for multi-domain research.
5. Automated pattern recognition: Using graph theory algorithms, this invention achieves automatic identification of specific patterns in Gan-Zhi relationships. This not only greatly improves analysis efficiency, but also reduces human errors, enhancing analysis accuracy.
6. High customizability: This system provides a flexible framework allowing users to customize pattern recognition rules, energy calculation methods, etc. This extensibility enables the system to adapt to different schools of thought and new research needs.
7. Data integration capability: Through unified data processing and visualization methods, this invention achieves interoperability between conceptual systems of different metaphysical schools. This integration capability promotes overall disciplinary development and enables comparative studies across schools.
8. Enhanced scientific rigor: By introducing modern scientific methods such as graph theory and data analysis, this invention significantly improves the scientific nature and objectivity of metaphysics research. This provides a new path for positioning and developing traditional metaphysics within the modern scientific system.

Overall, this invention represents a revolutionary breakthrough in metaphysics research methods. It not only systematizes and standardizes traditional analytical methods, but also greatly expands the application scope and scientific nature of metaphysics by introducing modern technological means. This innovative approach injects new vitality into the ancient discipline of metaphysics, enabling it to find its place in the modern scientific system and provide new perspectives and tools for research in multiple disciplines.

### III. INVENTION CONTENT

The purpose of this invention is to provide a graph theory-based system for quantifying and visualizing Gan-Zhi energy, used to study energy states in specific spatiotemporal segments and distribute results to different conceptual systems for reference by researchers from various schools of thought.

To achieve this purpose, the invention provides the following technical solution:

A graph theory-based system for quantifying and visualizing Gan-Zhi energy, characterized by including:
1) An eight-pillar coordinate position system including wildcards;
2) Predefined energy reaction patterns;
3) Five graph theory-based searchers (see Appendix A for details);
4) Predefined rules for modifying energy attributes based on patterns;
5) Custom energy reaction pattern priorities and parallel data processing algorithms (see Appendix B for details);
6) Rules for transposing Gan-Zhi data to the Five Elements system;
7) Interface for transposing Gan-Zhi data to the Five Elements system;
8) Six-pillar 3D detailed relationship view;
9) Interface for transposing Gan-Zhi data to the Ten Gods system.

The invention also provides a Gan-Zhi energy analysis method based on the above system, characterized by including the following steps:
1) Input date of birth;
2) Convert input date to standard Chinese four-pillar eight-character table;
3) Select flow year within the Yun; (refer to Appendix C for detailed terminology);
4) Determine the subject's energy state at a specific time point after birth;
5) Initialize attributes for each position in the table using different initial energy models;
6) Perform pattern recognition based on graph theory;
7) Use a flexible module selection system with position priority system and parallel algorithm support;
8) Adjust attributes of each position based on identified patterns;
9) Transpose the position system to Gan-Zhi dimension and map to Five Elements dimension;
10) Perform segmented 3D visualization and analysis of the position system;
11) Transpose the position system to Ten Gods dimension and visualize.

Compared with existing technology, this invention has the following beneficial effects:
1) By introducing graph theory and quantification methods, it transforms vague descriptions in traditional metaphysics into quantifiable and analyzable data, providing a scientific method for studying traditional ancient metaphysics;
2) Through unified data processing and visualization methods, it achieves interoperability between conceptual systems of different metaphysical schools, promoting disciplinary integration and development;
3) The flexible module selection system and parallel algorithm support improve the system's customizability and processing efficiency, compatible with algorithm requirements of different schools.

This invention provides an innovative three-layer disk diagram for mapping Gan-Zhi to Five Elements, characterized by:
1. Internalizing the relationship between position and energy in energy intensity, abandoning the traditional position system;
2. Shifting focus to internal reactions of Gan-Zhi symbols, making predictions more precise;
3. Adopting a three-layer disk structure, effectively solving the problem of difficulty in grasping key points when repeated elements appear;
4. Enhancing the expressiveness and interpretability of Gan-Zhi energy relationships through modern data visualization techniques.

Compared to traditional methods, the Gan-Zhi to Five Elements three-layer disk diagram of this invention has the following advantages:
1. Intuitiveness: Complex Gan-Zhi energy relationships are intuitively presented, facilitating analysis and understanding;
2. Precision: By focusing on internal reactions of Gan-Zhi symbols, prediction accuracy is improved;
3. Flexibility: Abandoning fixed position systems makes analysis more flexible and variable;
4. Innovation: Provides a new paradigm for combining traditional metaphysics with modern data analysis.

The six-pillar 3D detailed relationship view of this invention has the following advantages:
1. Preserves the spatial structure of traditional Gan-Zhi systems, facilitating understanding and analysis by professionals.
2. Deepens the dimension of energy analysis by introducing the CangGan layer.
3. Multi-level pattern recognition and connections reveal complex energy relationships.
4. 3D visualization provides a more intuitive and comprehensive view of energy distribution.

This invention also achieves, for the first time, visualization of Ten Gods system energy dynamics through innovative energy flow animation, providing a breakthrough intuitive representation for traditional metaphysical analysis. This visualization method not only clearly displays the energy distribution and bias of the analysis subject in the Ten Gods dimension but also intuitively presents its unique energy characteristics and flow patterns.

Specifically, the circular energy flow dynamic diagram of this invention adopts advanced data visualization techniques:
1. Node representation: The size of each node is determined by its energy intensity, providing a static overview of energy distribution.
2. Dynamic flow representation: Through carefully designed animation effects, moving visual elements (such as small balls) are used to simulate energy flow. The motion parameters of these visual elements (such as quantity, size, speed) are dynamically calculated according to customized algorithms, ensuring high consistency between visualization effects and underlying data.
3. Adjustable parameters: Specific parameters of flow visualization can be flexibly adjusted according to analysis needs, allowing the system to adapt to different analysis scenarios and objectives.
4. Force division: Dividing lines in the diagram effectively distinguish opposing forces, enhancing the dimension and depth of analysis.

The main advantages of this dynamic visualization method are:
Intuitiveness: Energy flow patterns are intuitively presented, making complex Ten Gods relationships easy to understand.
Dynamic characteristics: Through animation effects, energy efficiency can be displayed.
Multi-dimensional analysis: Combining node size and flow characteristics enables simultaneous analysis of static energy distribution and dynamic energy interactions.
Customization flexibility: Algorithms and visual parameters can be adjusted according to specific analysis needs to highlight key information.

Through this innovative visualization method, we have not only improved the accuracy and efficiency of traditional metaphysical analysis but also pioneered new paths for its application and development in modern contexts. This method provides researchers with a powerful tool, enabling them to gain deeper insights into and interpret complex metaphysical energy systems.

### System Customizability

The system design has high flexibility and customizability to adapt to different analysis needs and research fields. The main customizable aspects include:
1. New Pattern Definition:
   Users can define new fixed combination rules to expand the system's pattern recognition capabilities.
   For example: New Heavenly Stem and Earthly Branch combination patterns can be added, such as “six combination”.
2. Position Attribute Editing Strategy:
   Customize position attribute editing strategies for newly identified patterns.
   Set how new patterns affect node attributes such as energy multiplier and stability.
3. Five Elements Attribute (Serving Wuxing) Definition:
   Allow users to define specific Five Elements attributes for newly identified patterns.
   This enables the system to adapt to Five Elements theory interpretations from different schools.
4. Hidden Stem Energy Distribution (CangGan Energy Distribution):
   Provide customizable weighting methods for hidden stem energy distribution.
   Users can adjust the distribution ratios of mainQi, middleQi, and remainQi according to different theoretical systems.
5. Visualization Dimension Transposition:
   Allow users to choose different visualization methods to display analysis results.
   For example: Switch between six-pillar diagram, Five Elements disk diagram, and Ten Gods energy flow diagram, or adjust display parameters of these charts.
   When transposing dimensions between different analysis systems (such as Gan-Zhi, Five Elements, Ten Gods), allow definition of new mapping rules.
   For example: Add new Gan-Zhi combinations to specific Five Elements attribute mappings, or create custom energy flow visualization rules.
6. Searcher Parameter Adjustment:
   Allow users to adjust parameters of existing searchers (LTS, APS, ATS, APeS, and DRPM).
   For example: Adjust search distance, matching conditions, etc., to adapt to specific analysis needs.
7. Pattern Recognition Priority Setting:
   Provide an interface allowing users to customize recognition priorities for existing patterns.
   Users can adjust the processing order of different patterns according to analysis objectives, as shown in FIG. 5A and FIG. 5B.

Through these customization options, the system can adapt to various analysis needs, from traditional metaphysics to various fields of modern data analysis. Users can flexibly adjust various components of the system according to their theoretical framework and research objectives, thereby obtaining the most suitable analysis tool for their needs.

### IV. DESCRIPTION OF FIGURES

The Figures are an integral part of this specification and are used together with the specification to illustrate the principles of this invention.

FIG. 1: Overall flow chart of the quantitative analysis system from input to output.

FIG. 2A: Illustration of Gan-Zhi symbols and their contents.

FIG. 2B: Flow chart of converting Gregorian birth date to traditional Chinese Sexagenary cycle. The Sexagenary cycle uses eight characters to represent a specific moment.

FIG. 2C: Flow chart of selecting a time point after birth, converting it to the Sexagenary cycle and merging with the birth time.

FIG. 2D: Flow chart of concatenating static time-point energy data representing entity characteristics with spatiotemporal energy data from any subsequent time point, and an example of the concatenated result.

FIG. 3: Illustration of table initialization.

FIG. 3A: Data type chart for energy attribute initialization.

FIG. 3B: Coordinate chart for position system initialization.

FIG. 3C: Illustration of single position attributes.

FIG. 4: Flow chart of converting metaphysics table into graph theory structure and performing search.

FIG. 4A: Illustration of settings and classification after position node conversion.

FIG. 4B: Structural diagram of five basic searchers.

FIG. 4C: Possible structure diagram of advanced searcher (I).

FIG. 4D: Possible structure diagram of advanced searcher (II).

FIG. 4E: Chart of pattern search symbol settings and searcher selection.

FIG. 4F: Case illustration of basic searchers (I).

FIG. 4G: Case illustration of basic searchers (II).

FIG. 4H: Case illustration of advanced searchers.

FIG. 5: Flow chart of data processing after setting reaction pattern priorities.

FIG. 5A: Interface illustration of reaction pattern priority setting (before setting).

FIG. 5B: Interface illustration of reaction pattern priority setting (after setting).

FIG. 5C: Flow chart of processing by priority.

FIG. 5D: Table of rules for attribute adjustment of identified locations participating in a recognized pattern.

FIG. 5E: Illustration of an example process for attribute adjustments at each position after pattern recognition.

FIG. 6: Generation process of illustrative diagram for mapping quantitative system data to Five Elements system.

FIG. 6A: Flow chart of node filtering process.

FIG. 6B: Principle diagram of merging similar items among nodes.

FIG. 6C: Chart of reaction pattern matching condition settings and Five Elements conversion rules.

FIG. 6D: Illustrative model of mapping Gan-Zhi system to Five Elements system (without data).

FIG. 6E: Illustrative model of mapping Gan-Zhi system to Five Elements system (with data).

FIG. 6F: Attribute illustration of single Gan-Zhi element in the mapping model.

FIG. 7: Flow chart of detailed decomposition visualization of quantitative system data based on position system.

FIG. 7A: Illustration of node splitting into six-pillar system.

FIG. 7B: Illustration of horizontal layering and relationship recognition of nodes (Gan).

FIG. 7C: Illustration of horizontal layering and relationship recognition of nodes (Zhi).

FIG. 7D: Illustration of horizontal layering and relationship recognition of nodes (CangGan).

FIG. 7E: Six-pillar interaction diagram.

FIG. 7F: Description of pattern recognition settings in the case.

FIG. 7G: Node attribute diagram in the six-pillar interaction diagram.

FIG. 7H: Weight distribution table for CangGan quantity.

FIG. 7I: Diagram of Canggan nodes' layered visual representation and planar computational positioning.

FIG. 8: Flow chart: Transposition of quantitative system data to Ten Gods system and its dynamic visualization process.

FIG. 8A: Node filtering illustration: Selective removal process of Zhi layer nodes.

FIG. 8B: Conversion rule matrix: Standardized conversion rules for mapping Gan-Zhi elements to Ten Gods system based on Day Master.

FIG. 8C: Ten Gods system conversion example: Display of Ten Gods attribute distribution after applying conversion rules to a specific case.

FIG. 8D: Energy intensity aggregation diagram: Visualization expression of summing and merging similar items in the energy intensity dimension based on Ten Gods classification as clustering basis.

FIG. 8E: Static network diagram of Ten Gods energy flow intensity: Force-directed graph with fixed node positions, showing the relative intensity of energy flow between Ten Gods categories.

FIG. 8F: Dynamic circular diagram of Ten Gods energy flow: Circular topology structure based on fixed node positions, intuitively presenting the time-varying characteristics of Ten Gods energy flow speed through animation effects.

### V. SPECIFIC IMPLEMENTATION METHOD

The preferred embodiments of this invention are shown in the accompanying Figures. The following detailed description will refer to these Figures, but the scope of this invention is not limited to the specific examples described.

This invention provides a graph theory-based Gan-Zhi energy quantification and visualization system. The core of this system lies in combining traditional Gan-Zhi theory with modern graph theory, data analysis, and visualization techniques, providing a new methodology and technical framework for periodic energy analysis.

### Core Technical Framework

The core technical framework of this invention includes the following key components:
1. Time Conversion Module: Converts various time representation methods into standardized Gan-Zhi representations.
2. Graph Theory Model Construction: Builds complex network graph models based on Gan-Zhi relationships.
3. Energy Quantification Algorithm: Quantifies Gan-Zhi relationships through preset rules and custom calculation methods, such as using the product of base energy and energy multiplier to calculate energy intensity.
4. Pattern Recognition System: Uses graph theory algorithms to identify specific patterns in Gan-Zhi relationships.
5. Multi-dimensional Visualization Engine: Transforms analysis results into intuitive multi-dimensional visual representations.
6. Cross-domain Mapping Module: Maps Gan-Zhi energy analysis results to conceptual frameworks in different disciplinary fields.

### Implementation Process

The typical implementation process of this invention includes the following steps:
1. Data Input: Input the time point or time series to be analyzed.
2. Time Conversion: Convert the input time into a standardized Gan-Zhi representation.
3. Graph Theory Model Construction: Build a complex network graph model based on the converted Gan-Zhi data.
4. Energy Quantification: Quantify the energy of each node and relationship in the graph model.
5. Pattern Recognition: Identify specific energy patterns in the graph model.
6. Data Analysis: Conduct in-depth data analysis based on the identified patterns.
7. Result Visualization: Present the analysis results through multi-dimensional visualization techniques.
8. Cross-domain Mapping: Map the results to conceptual frameworks in specific fields, generating domain-specific analysis diagram.

The methods and systems of this invention have high flexibility and scalability. By adjusting parameter settings, adding new analysis modules, or modifying processing procedures, it can adapt to specific needs in different fields. Therefore, the graph theory-based Gan-Zhi energy quantification and visualization method provided by this invention can flexibly adapt to any field that requires periodic energy analysis.

It should be understood that the specific implementation methods described above are only examples and should not be construed as limitations on the scope of this invention. Those skilled in the art can make various modifications and variations to this invention without departing from the spirit and scope of this invention. The scope of this invention is defined by the appended claims and their equivalents.

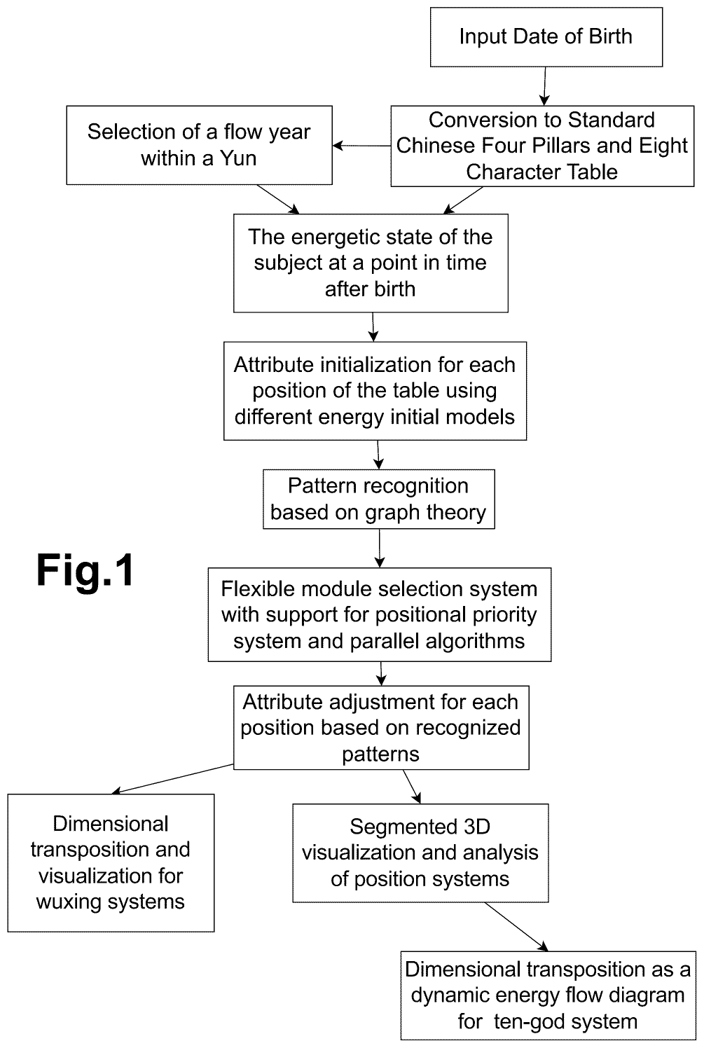

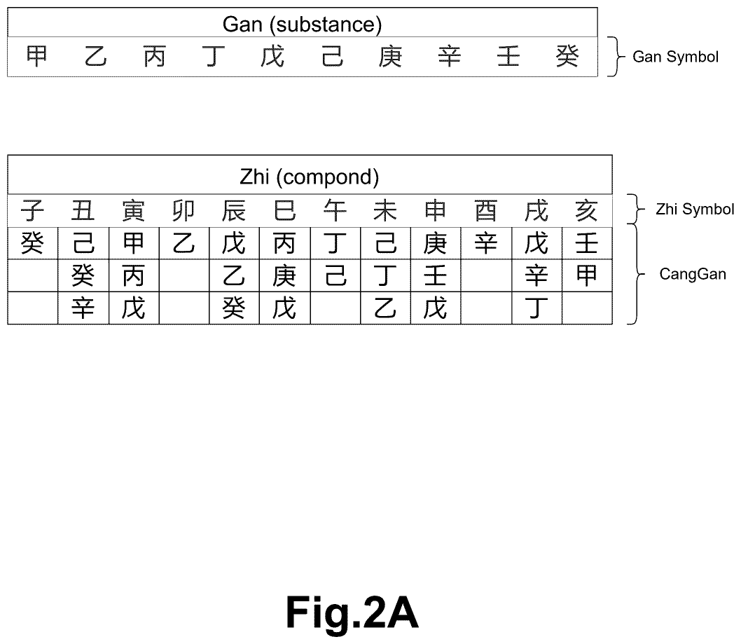

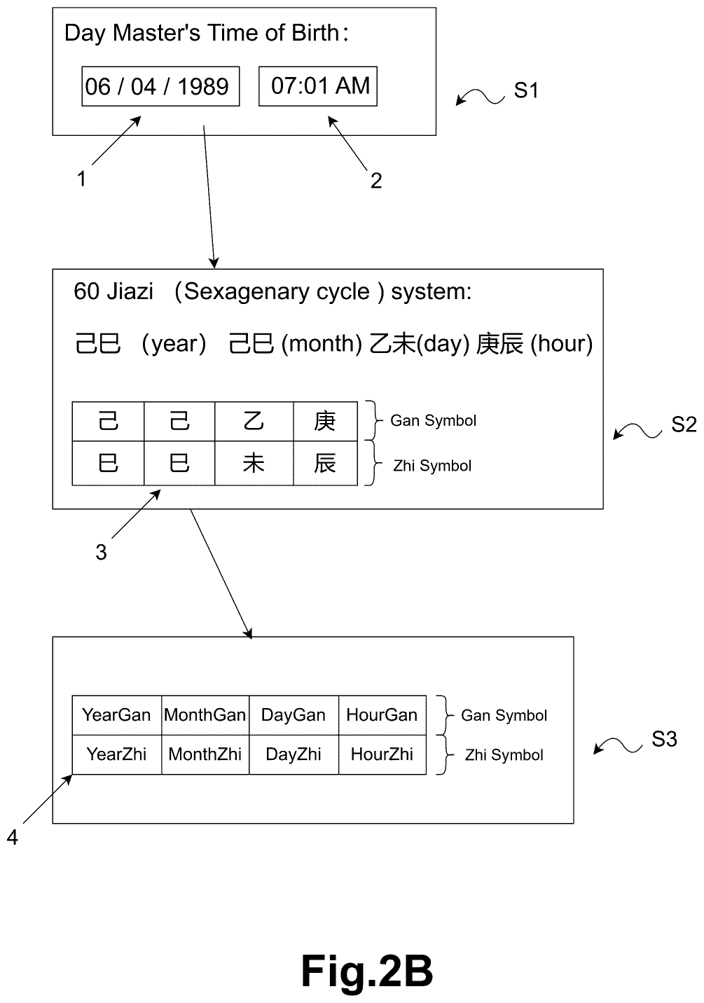

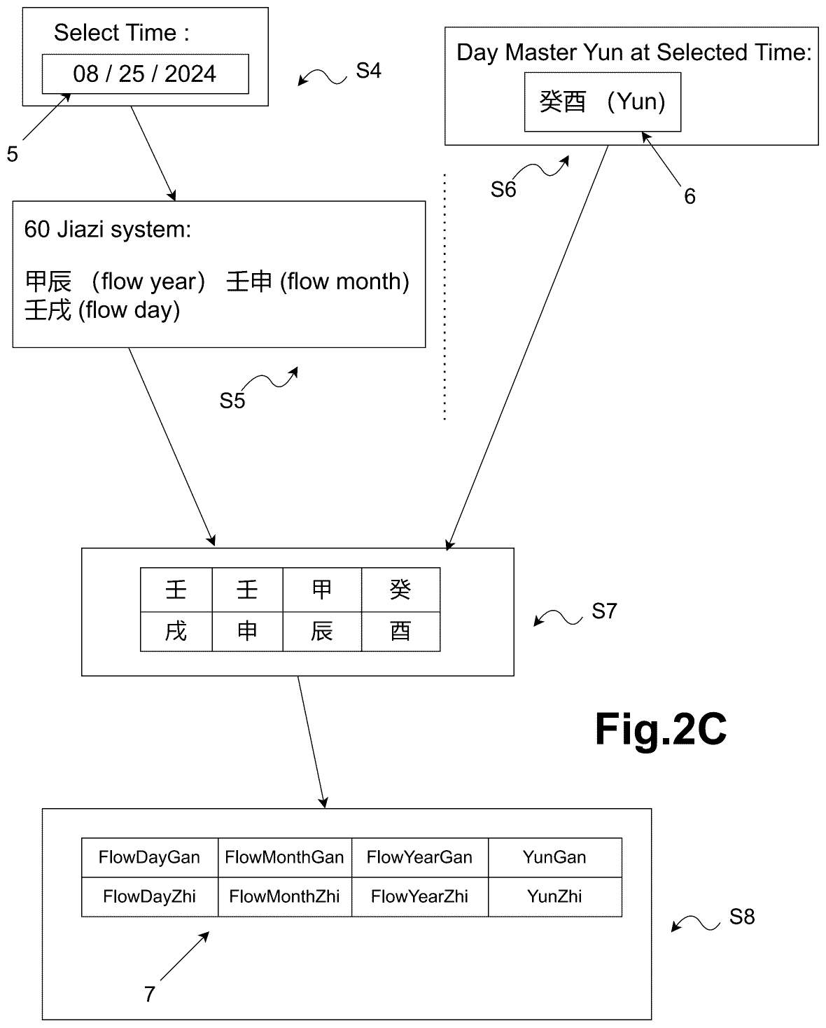

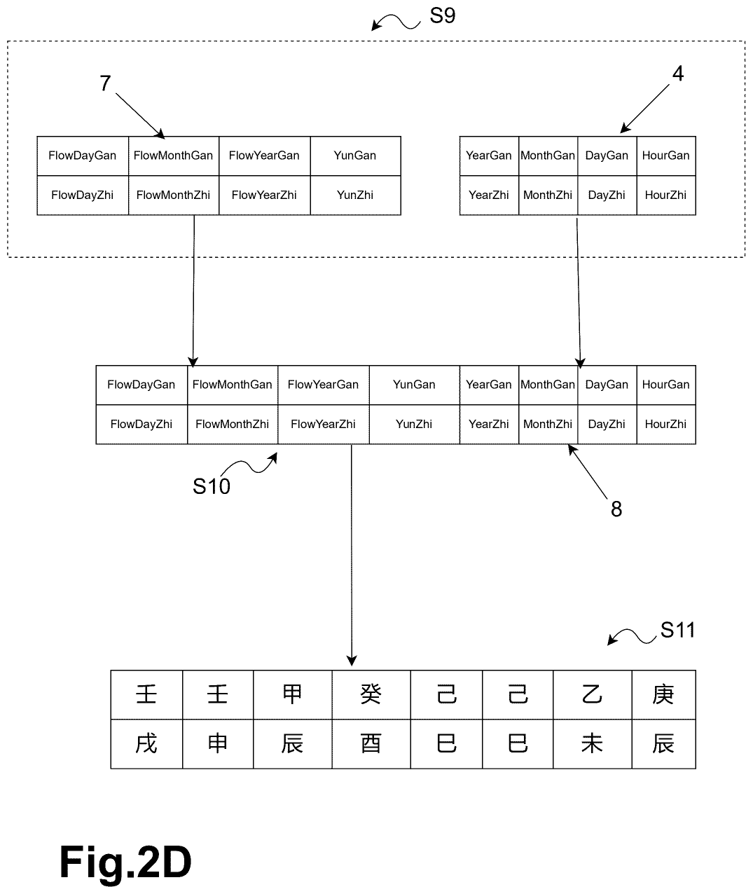

FIG. 1 shows the overall flow diagram of the Gan-Zhi energy analysis system, illustrating the process from initial data input to the final mapping and display of analysis results in different conceptual systems. The core steps of this system include:
[S1] Input the characteristic time point of the analysis subject. The input includes two parts: [1] Gregorian calendar date, and [2]24-hour time (hour:minute). This time point can be diverse, such as an individual's birth moment or the first opening time of a stock market, depending on the nature of the analysis subject.
[S2] Convert the input Gregorian time to the Sixty Jiazi Chronology representation. The Sixty Jiazi Chronology is based on the Gan-Zhi system, where:
Gan (Heavenly Stems): As shown in FIG. 2A, are basic elements (substances), with each Gan symbol representing a single energy attribute.
Zhi (Earthly Branches): Are compound structures, containing combinations of 1-3 Gan elements. These implicit Gan elements are called CangGan (Hidden Stems).

The conversion process details are as follows:
Gregorian year is converted to a combination of 1 Gan symbol and 1 Zhi symbol
Gregorian month is converted to a combination of 1 Gan symbol and 1 Zhi symbol
Gregorian day is converted to a combination of 1 Gan symbol and 1 Zhi symbol
Hour is converted to a combination of 1 Gan symbol and 1 Zhi symbol
[3] The above 4 Gan-Zhi combinations constitute the complete conversion result.
[S3] The converted result contains 8 parts, named as [4]:
YearGan, YearZhi
MonthGan, MonthZhi
DayGan, DayZhi
HourGan, HourZhi

This representation method comprehensively captures the energy characteristics of the time point in the Gan-Zhi system, laying the foundation for subsequent energy analysis.

FIG. 2C shows the process of analyzing the Gan-Zhi energy state at a specific time point, with the following specific steps:
[S4] Select the time point to be analyzed [5], usually a date after the birth or start of the subject (such as an individual or event).
[S5] Convert the selected Gregorian date to the Sixty Jiazi Chronology representation. The conversion result contains 6 parts:
Year Gan, Year Zhi
Month Gan, Month Zhi
Day Gan, Day Zhi
[S6] Determine the Luck Pillar (Yun) where the analysis time point is located. Yun is a 10-year cycle, its arrangement follows traditional industry-standard methods and varies from person to person. The Yun information provides an additional 2 parts [6]:
Yun Gan,Yun Zhi
[S7] Merge the 6 parts from [S5] and the 2 parts from [S6].
[S8] The merged data parts are named as [7]: FlowDayGan, FlowDayZhi, FlowMonthGan, FlowMonthZhi, FlowYearGan, FlowYearZhi, YunGan, YunZhi
[S10] Concatenate [7] and [4](the subject's Gan-Zhi information at birth) to form a complete analysis basis [8].
[S11] Display the concatenation result. This chart comprehensively represents the interaction between these three aspects:
The subject's inherent energy at birth (lifelong identifier)
The influence of the Luck Pillar (Yun)
The objective energy state at the specific time point
[S12] Initialize attributes for each position on the chart.
[S13] Apply a customized digital energy model [9] to assign energy intensity values to each position. Note:
Energy ratios vary by position
The energy of the DayGan position where the Day Master is located is consistently 0
[S14] Add other attributes to each position, including but not limited to:
coordinates
yinyang polarity
wuxing element category
detected reaction
energy multiplier
stability

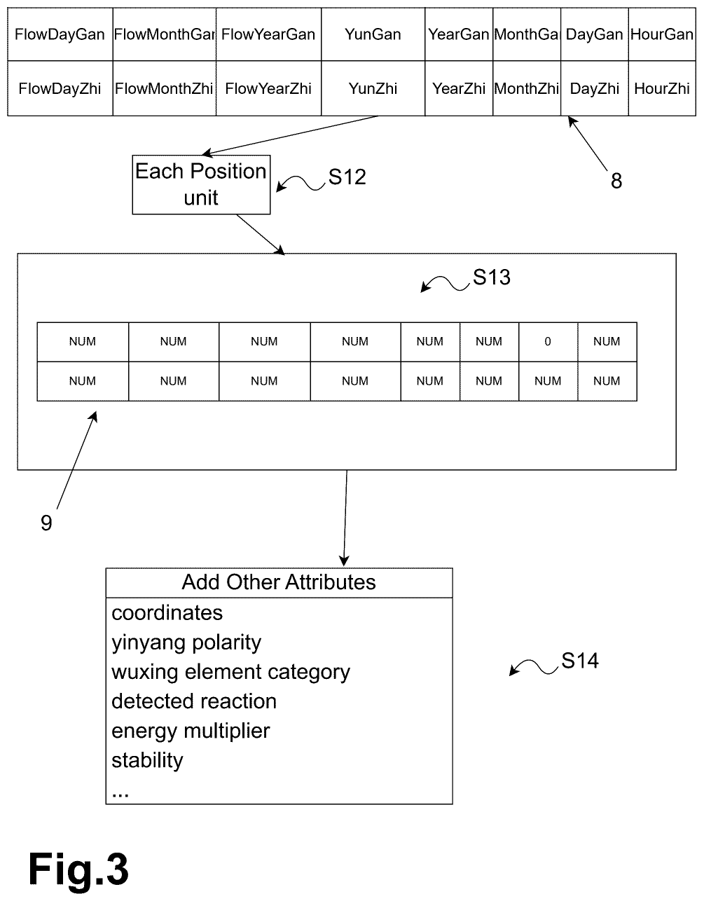

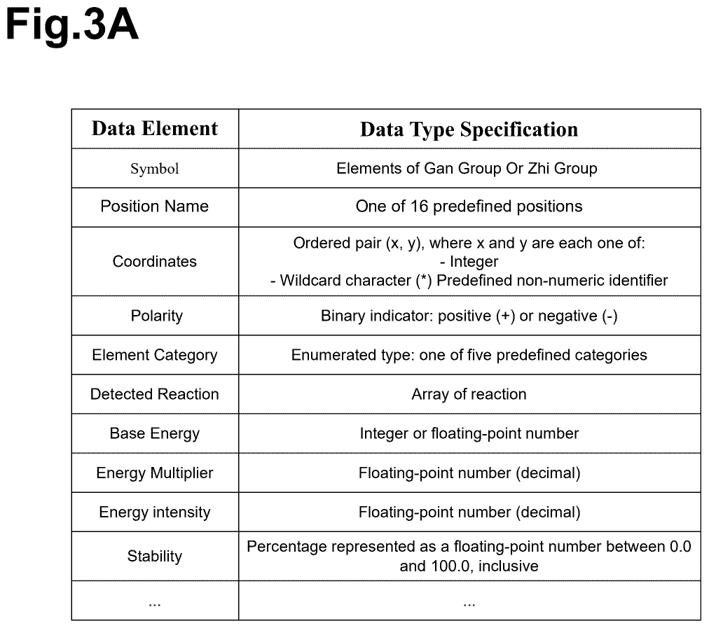

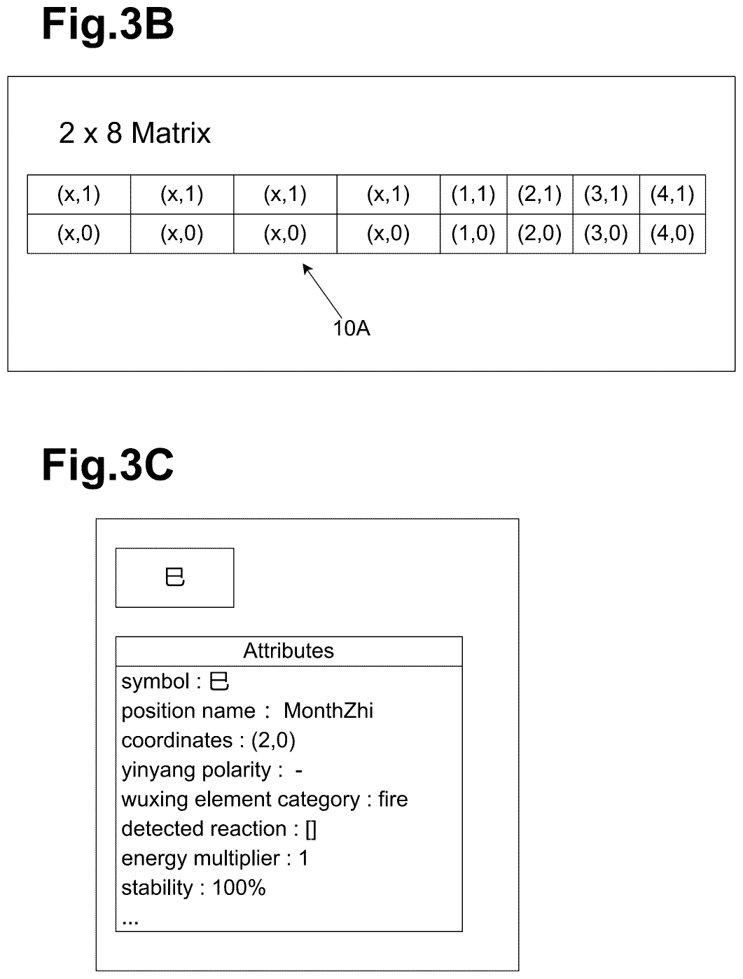

FIG. 3A details the data format of position attributes. Among them, the calculation method for energy intensity is: base energy * energy multiplier. This calculation method allows the system to dynamically adjust energy intensity according to different situations, improving the flexibility and accuracy of the analysis.
FIG. 3B explains that position attributes are divided into two categories:
Specific numerical coordinates
Wildcard coordinates
[10A] Special case: Coordinates (x,0) indicate that the distance between this position and any other position except itself is 1.
FIG. 3C shows an example of attributes after assigning values to a single position.
This series of steps constructs a comprehensive Gan-Zhi energy analysis framework, laying the foundation for subsequent pattern recognition and in-depth analysis.

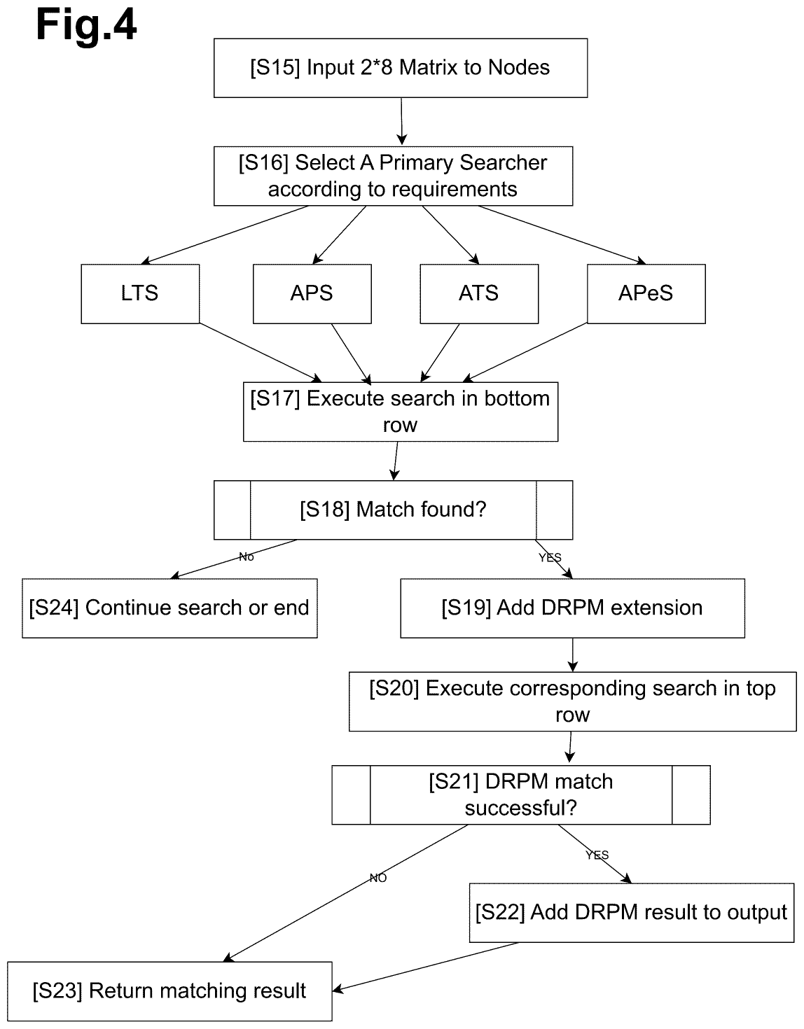

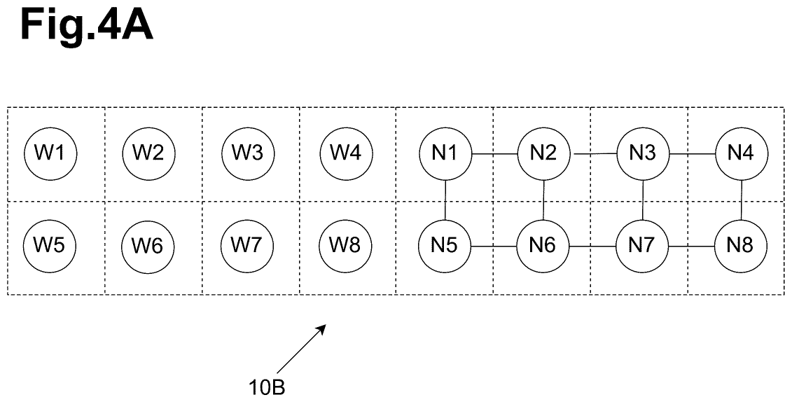

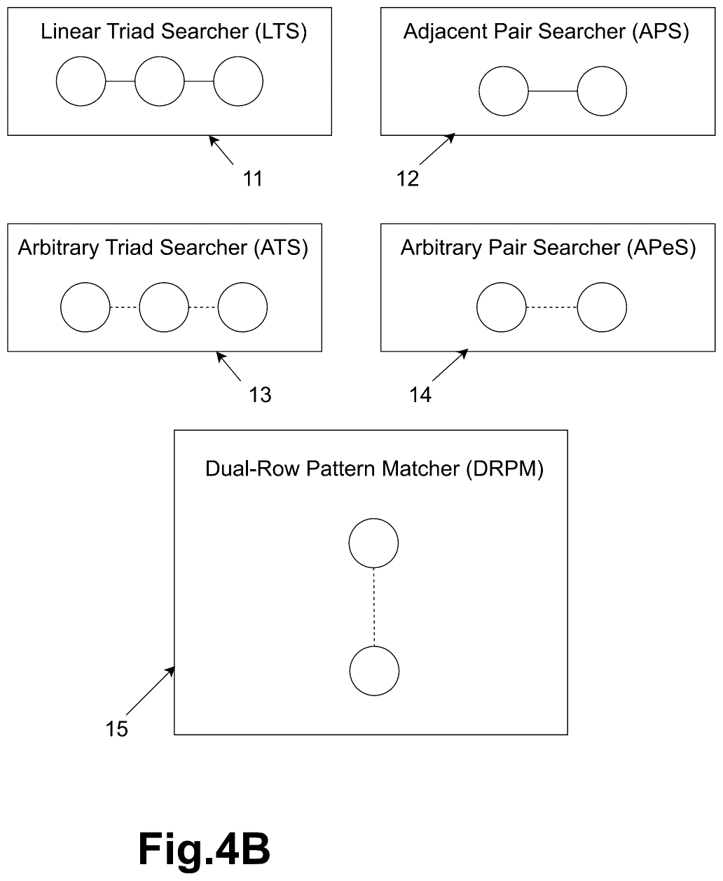

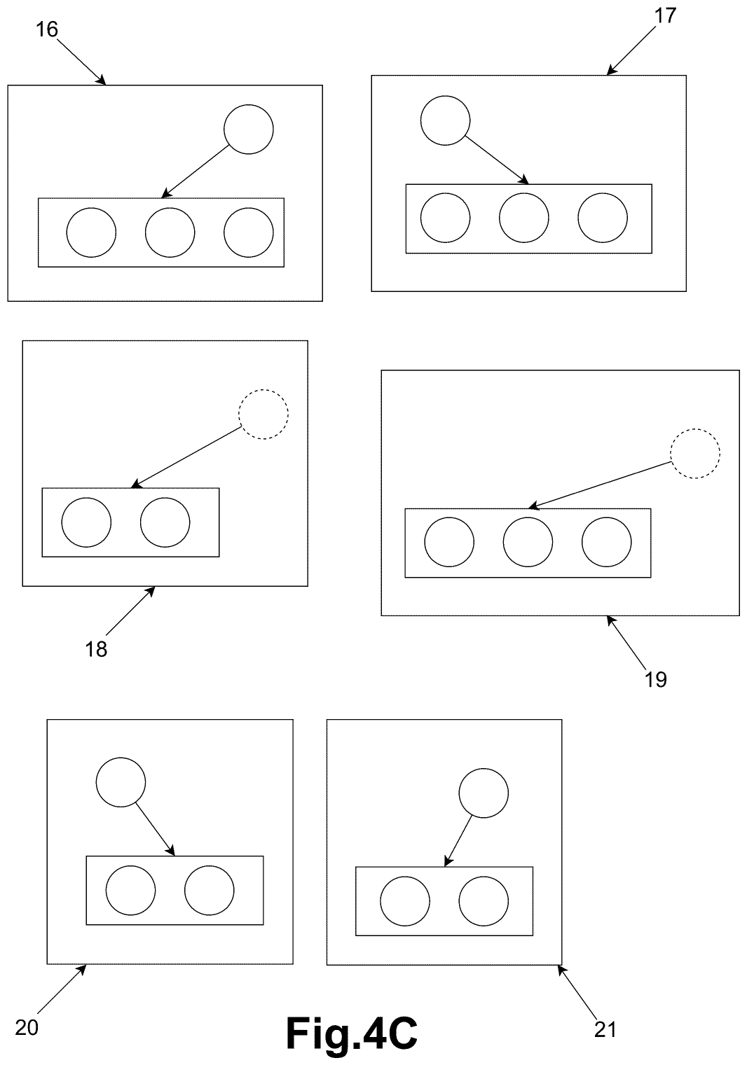

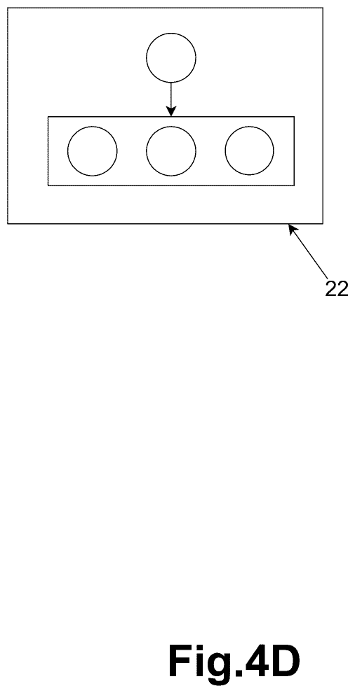

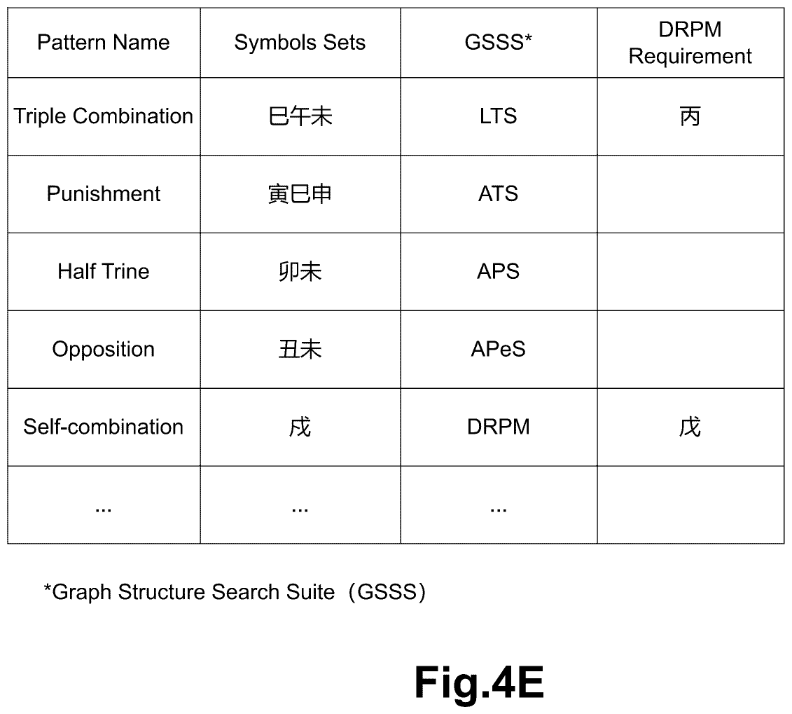

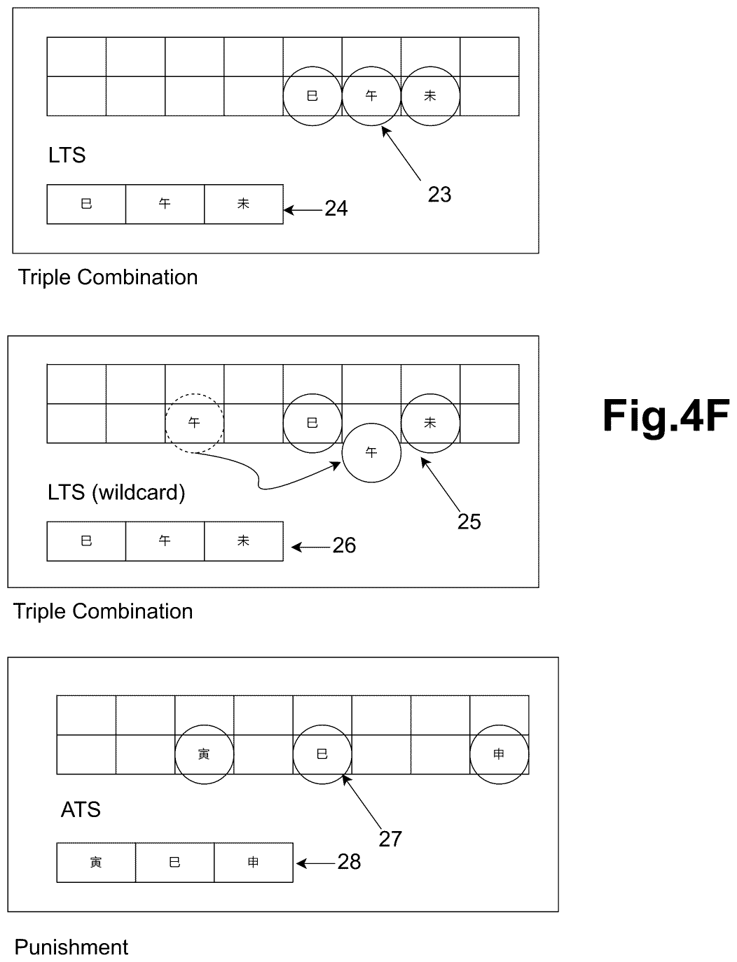

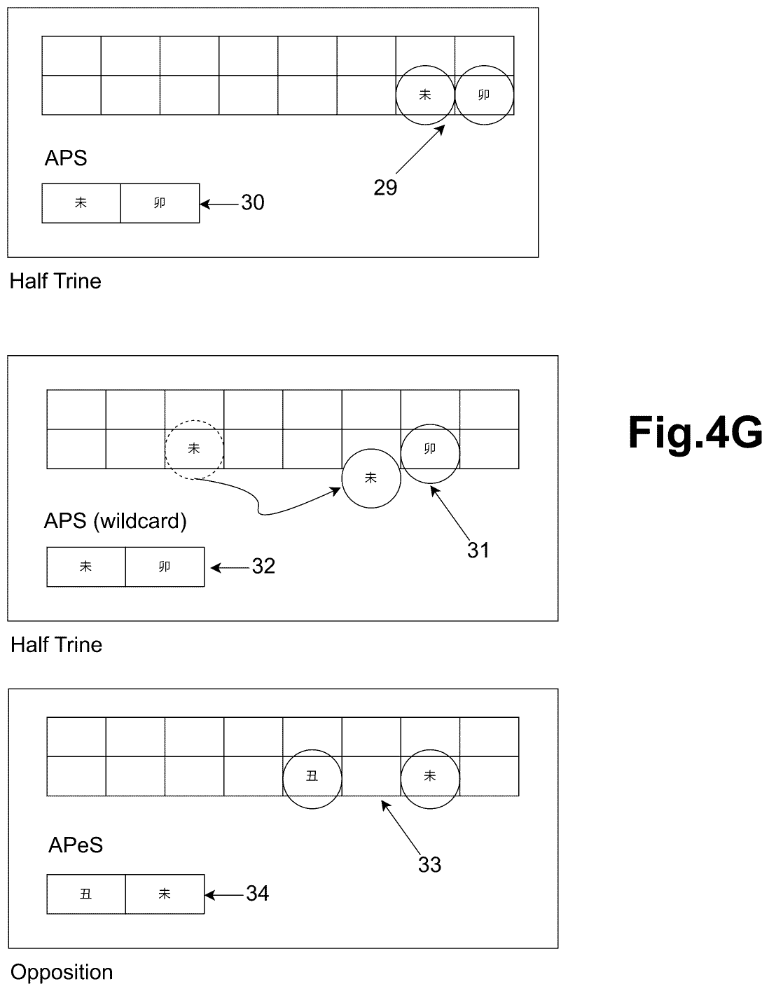

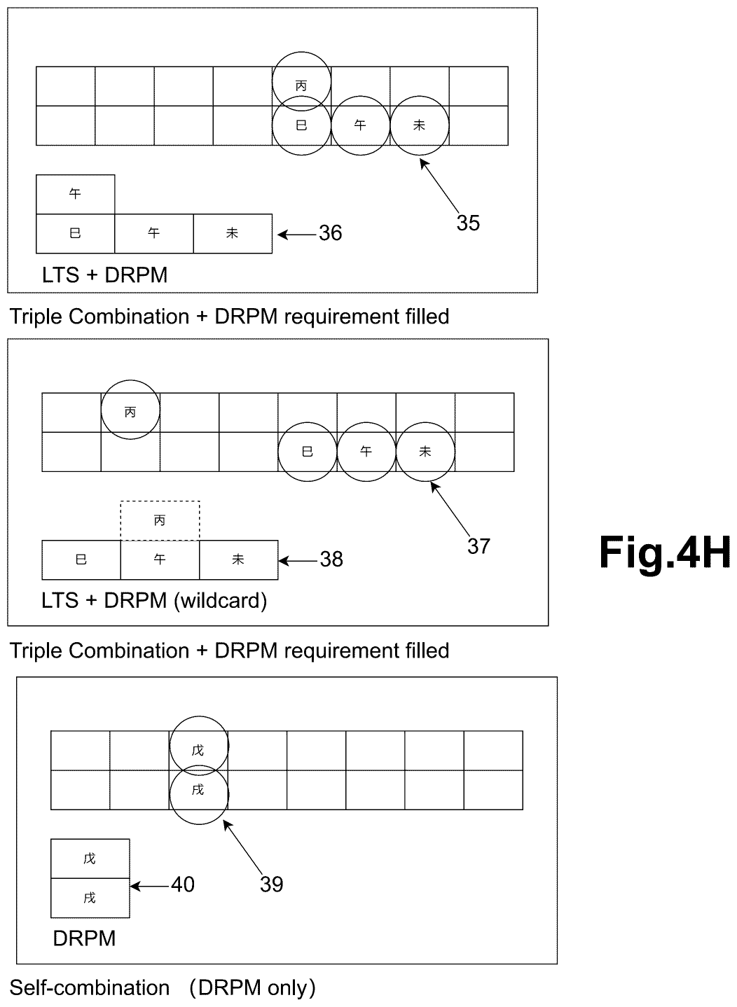

FIG. 4 illustrates the method of combining the Gan-Zhi energy table with computer graph theory techniques. This combination provides a modernized, systematic computational framework for traditional Gan-Zhi analysis. The specific steps are as follows:
[S15] Node Processing: Convert the position table in [8] into nodes [10B]. FIG. 4A shows a schematic diagram of nodes, including two types of nodes:
N-type nodes: Fixed nodes, with a distance of 1 between adjacent nodes, connected by solid lines.
W-type nodes: Wildcard nodes, with a distance of 1 from any node, represented without connection lines.
[S16] Pattern Recognition: Perform pattern recognition on nodes to identify specific patterns and find result components. FIG. 4E lists several requirements for pattern recognition, which can be customized according to actual needs.

For example, to find a pattern named “punishment”, the corresponding searcher needs to be selected from the GSSS (Graph Structure Search Suite) column. Using this searcher in the lower-level nodes of [S17](algorithm details in Appendix A), if a fixed combination conforming to the specified symbol sets is found, the result component is successfully identified.

FIG. 4B shows the structure of 5 types of searchers:
Basic searchers: [11] Linear Triad Searcher (LTS): 3-element finite horizontal
distance searcher [12] Adjacent Pair Searcher (APS): 2-element finite horizontal
distance searcher [13] Arbitrary Triad Searcher (ATS): 3-element searcher without
distance limitation [14] Arbitrary Pair Searcher (APeS): 2-element searcher without
distance limitation
Advanced searcher: [15] Dual-Row Pattern Matcher (DRPM): Searches in vertical positions, without horizontal distance requirements
DRPM normally serves as an auxiliary searcher, performing advanced searches after the basic search is completed.
FIG. 4B-4D show the combined use of DRPM with other searchers: [16][17][22] DRPM combined with LTS [18][19] DRPM combined with APS, involving wildcard nodes [20][21] DRPM combined with APS, not involving wildcard nodes
FIG. 4F-4H show successful identification cases for various searchers: FIG. 4F: [23][24] LTS identifying triple combination in fixed positions [25][26] LTS identifying triple combination including wildcard positions [27][28] ATS identifying punishment pattern
FIG. 4G: [29][30] APS identifying half trine in fixed positions [31][32] APS identifying half trine including wildcard positions [33][34] APeS identifying opposition pattern
FIG. 4H: [35][36] LTS followed by DRPM, identifying fixed nodes above [37][38] LTS followed by DRPM, identifying wildcard nodes above [39][40] Using DRPM alone, identifying self-combination pattern

Search process:
For searchers other than DRPM: Repeat steps [S16]-[S23]
For DRPM searcher only: Jump directly from [S16] to [S19]
This graph theory-based search method greatly improves the accuracy and efficiency of Gan-Zhi energy analysis, providing a scientific and systematic computational framework for traditional metaphysical analysis.

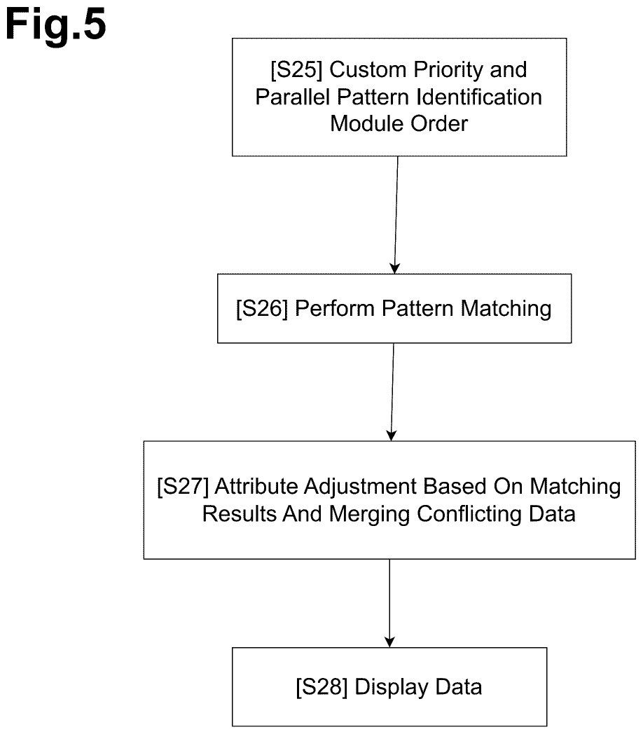

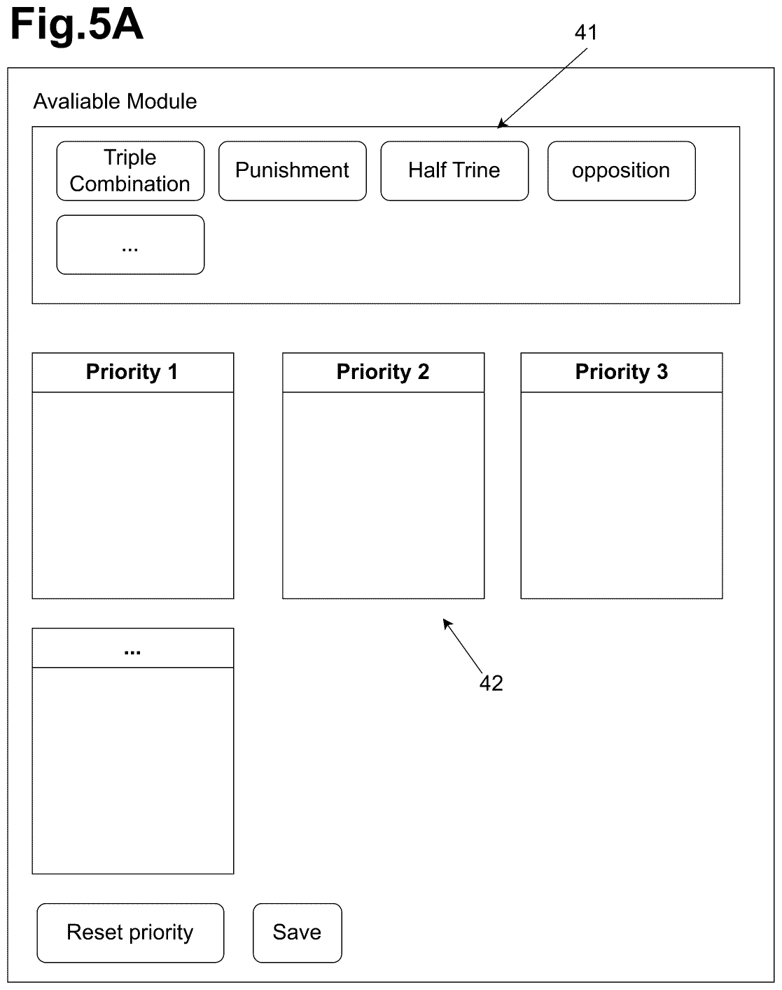

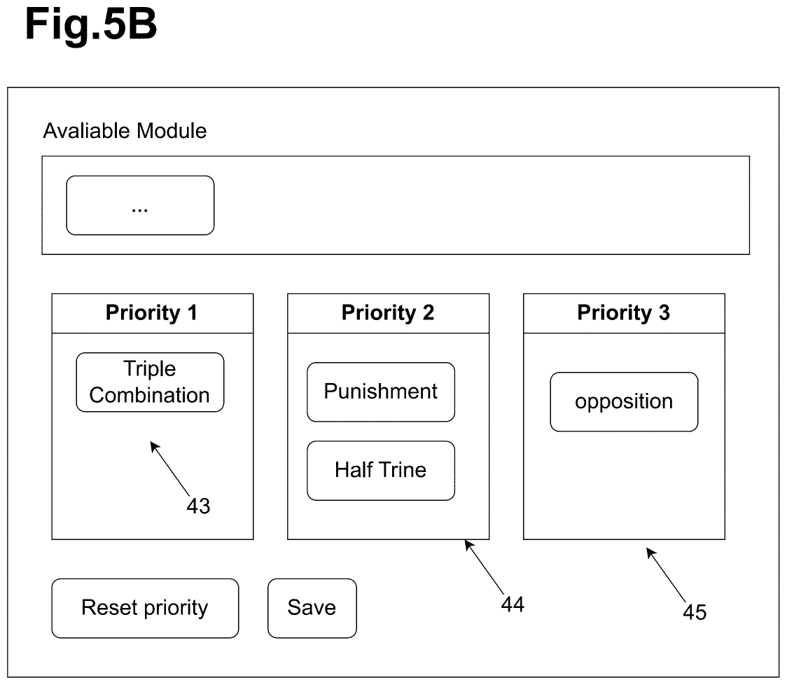

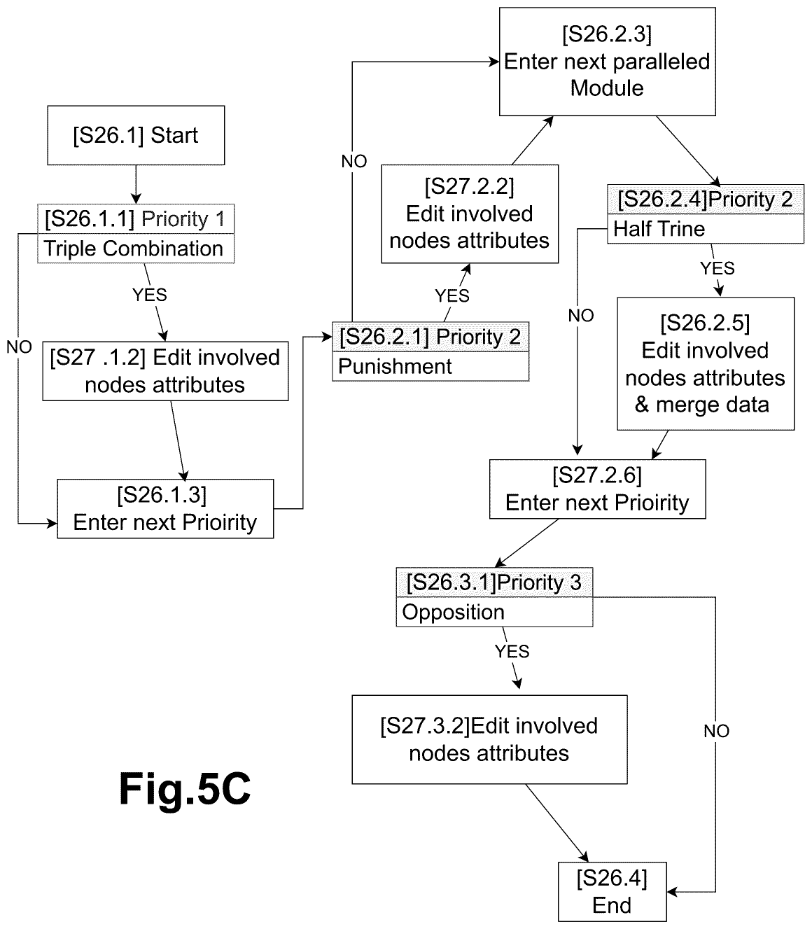

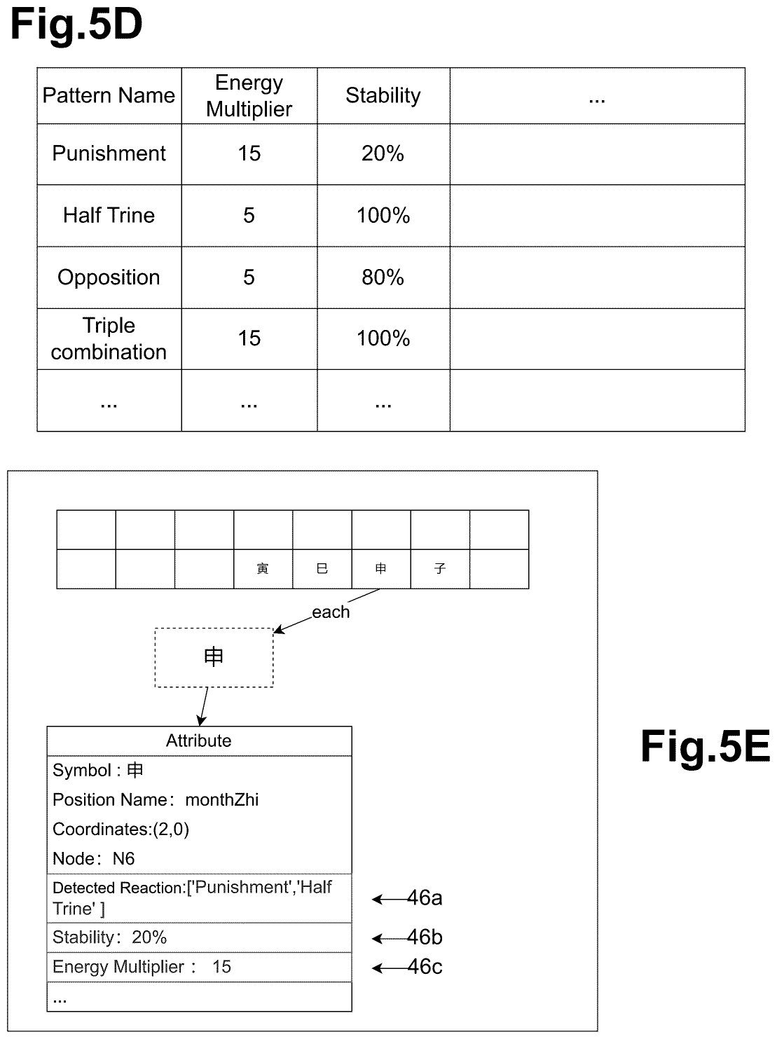

FIG. 5 shows the flow diagram of pattern recognition priority setting and parallel computation. This process is crucial for optimizing the efficiency and accuracy of Gan-Zhi energy analysis. The specific steps are as follows:
[S25] Set pattern recognition priorities and parallel computation mode (see Appendix B for details):
Priority determines the order of node occupation. Nodes occupied by high-priority modules cannot be re-identified by lower-priority modules.
In FIG. 5A, [41] displays the Available Module selection box, containing predefined pattern recognition modules.
[42] is a blank priority setting box where users can drag modules to set priorities.

Modules within the same priority can be computed in parallel.
Case analysis (based on FIG. 5B): [43] Triple combination: Priority 1, runs first. [44] Priority 2: Includes punishment and half trine modules, running sequentially.
Execution process: [S26.1] Start running [S26.1.1] Priority 1: Execute triple combination pattern recognition. [S27.1.2] Edit matching node attributes according to the rules in FIG. 5D:

$$energy multiplier = 20$$

$$stability = 100 \% [ S 26.1 \text{.3} ] Move to the next priority$$

[S26.2.1] Priority 2: Execute punishment pattern recognition. [S27.2.2] Edit node attributes according to FIG. 5D rules:

$$energy multiplier = 5$$

$$stability = 100 \% [ S 26.2 \text{.3} ] Nodes are mutually exclusive between different priorities$$

to avoid data conflicts.
[S26.2.4] Priority 2: Execute half trine pattern recognition. [S27.2.6] Edit node attributes according to FIG. 5D rules:

$$energy multiplier = 5$$

$$stability = 100 \%$$

Conflict handling (punishment vs half trine): According to FIG. 5E, handle conflicts as follows: [46a] detected reaction: Add both identified patterns to the array for superposition processing. [46b] stability: Take the minimum value, i.e., 20%. [46c] energy multiplier: Take the maximum value.
[S26.2.6] Move to the next priority
[S26.3.1] Priority 3: Execute opposition pattern recognition. [S27.3.2] Edit node attributes according to FIG. 5D rules:

$$energy multiplier = 5$$

$$stability = 80 \%$$

[S26.4] End of process

It should be noted that the algorithm conflict merging method described in this invention is not limited to the above implementation. In practical applications, other appropriate merging algorithms or methods can be adopted according to specific needs to resolve potential algorithm conflicts, ensuring the flexibility and adaptability of the system. This modular and customizable design enables the system to adapt to various complex Gan-Zhi energy analysis scenarios, improving the accuracy and efficiency of analysis.

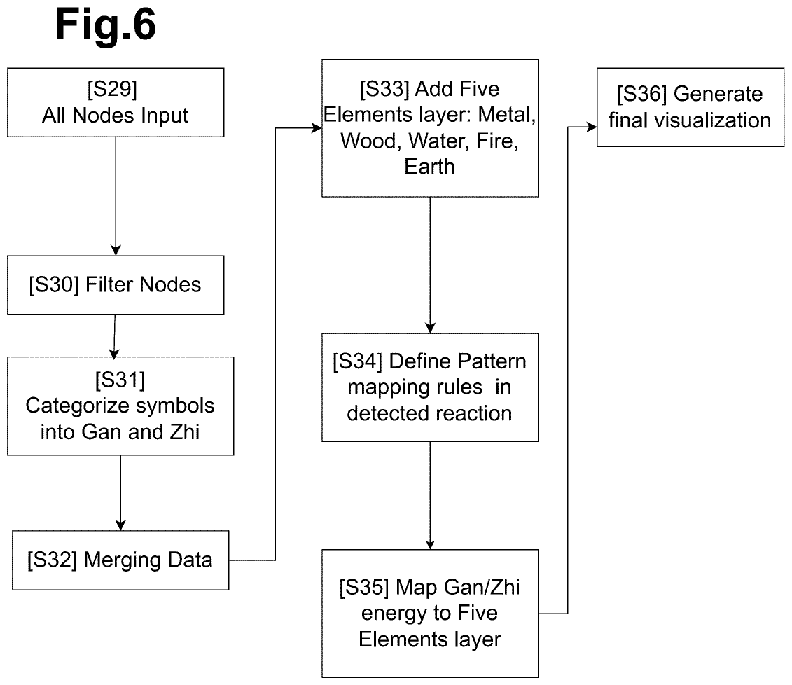

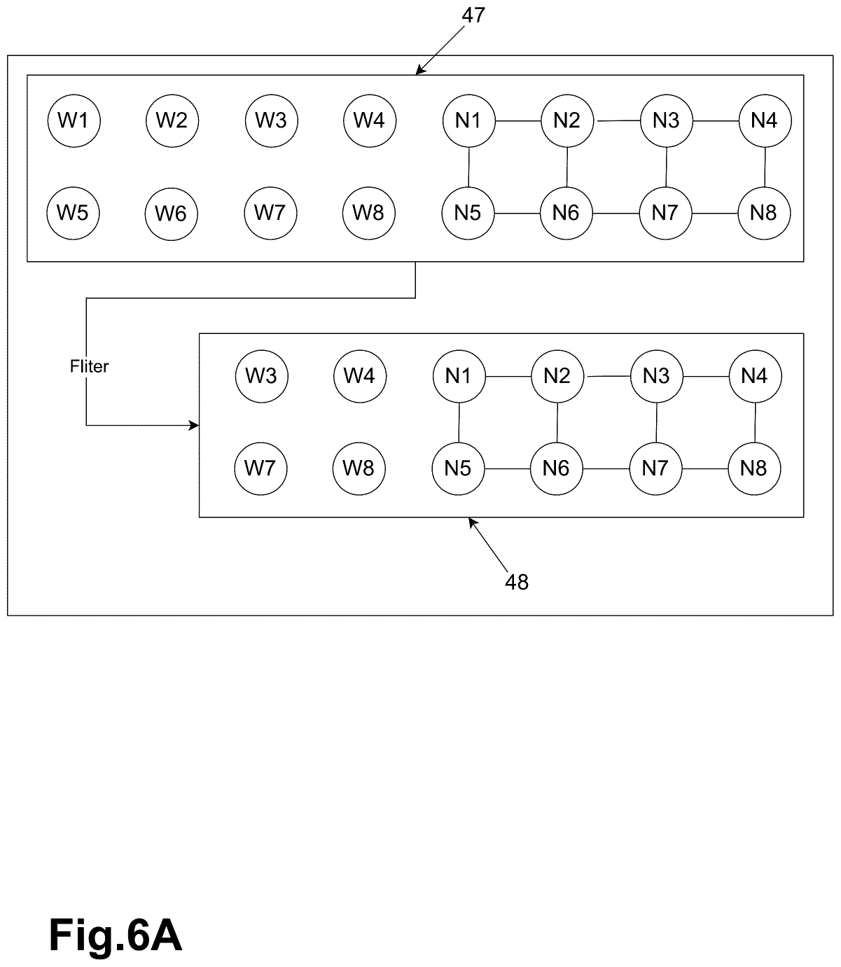

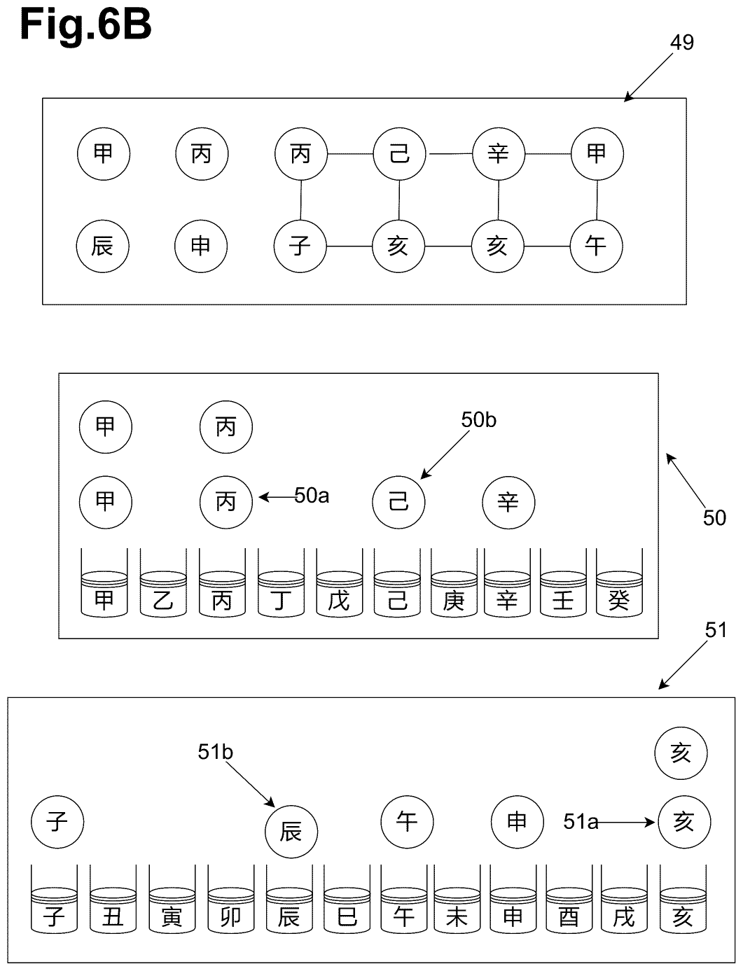

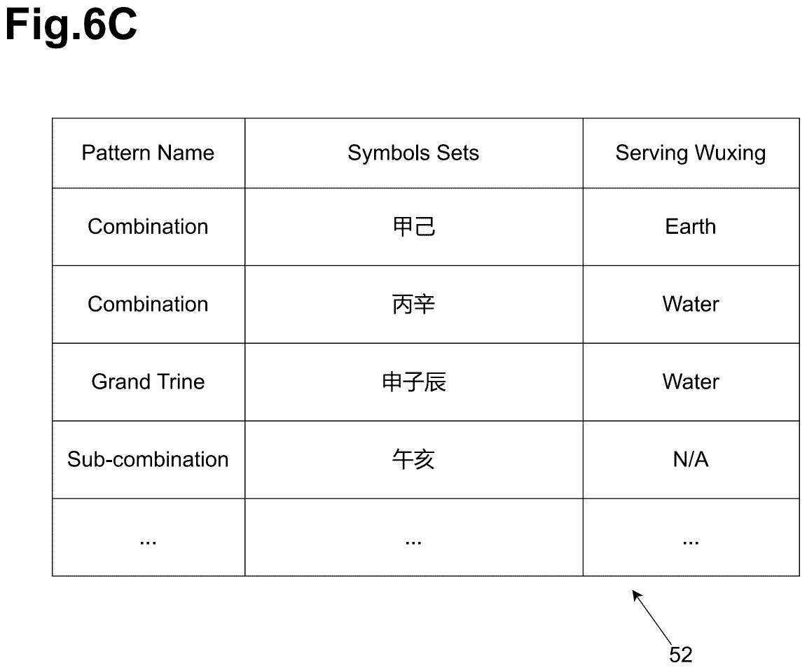

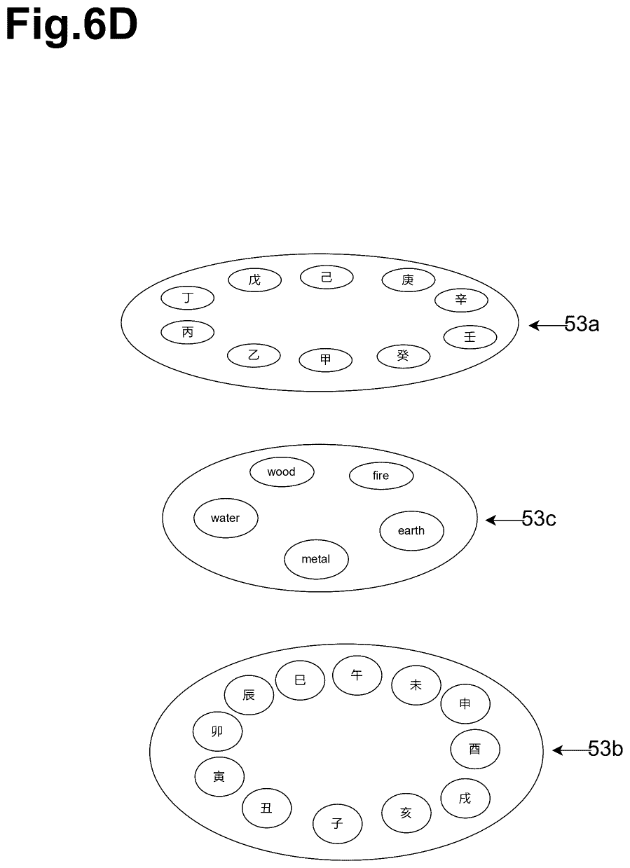

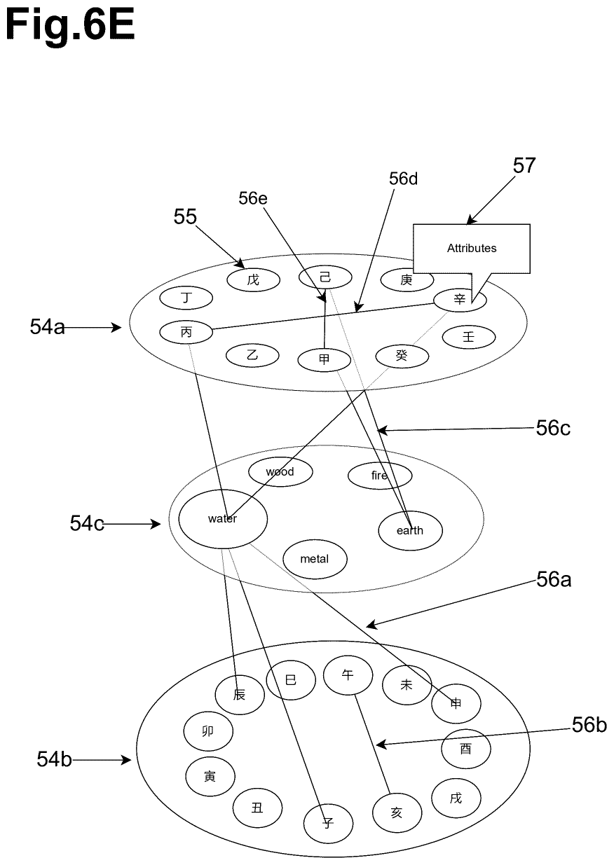

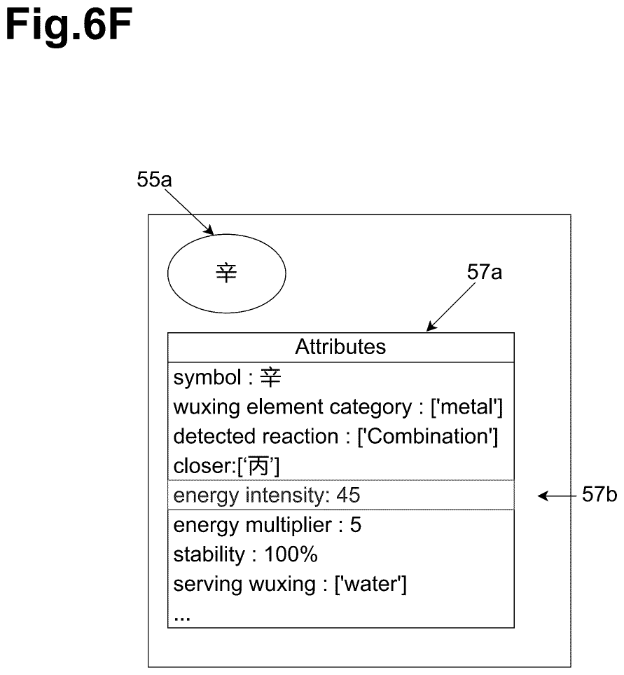

FIG. 6 describes a process of dimension conversion and visualization of quantified node attribute data. This process aims to provide an intuitive display of Gan-Zhi energy analysis results. The specific steps are as follows:
[S29] Data input: Input all nodes and their attributes, for example, [47] contains 16 nodes.
[S30] Node filtering: Filter out unimportant nodes (W1, W2, W5, W6). [48] shows the node structure after filtering.
[S31] Symbol attribute merging: Merge similar items using the basic symbol attributes of nodes [49].
Gan symbols ([50]): 10 types in total. As shown in [50a], identical symbols in nodes W4 and N1 are grouped together.
Zhi symbols ([51]): 12 types in total. As shown in [51a], identical symbols in nodes N6 and N7 are grouped together.
[S32] Energy intensity merging: Sum up the energy intensity [57b] attribute values of symbols of the same type.
[S33] Wuxing layer initialization: Initialize the Wuxing (Five Elements) visualization layer [53c].
[S34] Mapping rule definition: Define mapping rules from patterns to Wuxing.
[S35] Relationship mapping processing: Perform relationship mapping according to the defined rules.
[S36] Visualization display: Display the processed image.

FIG. 6C provides several examples of mapping rules:
Zhi layer mapping to Wuxing layer: [54b] In the Zhi layer, the symbols set ‘ [symbol] ’ corresponds to the pattern name ‘grand trine’. Rule: The Serving Wuxing for all symbols is ‘water’. Operation: Map to the ‘water’ item in the wuxing layer [54c] through connection line [56a].
Zhi layer internal connection: [54b] In the Zhi layer, the symbols set ‘ [symbol] ’ corresponds to the pattern name ‘sub combination’. Rule: Serving Wuxing is not applicable. Operation: Connect within the same layer through connection line [56b].
Gan layer mapping to Wuxing layer: [54a] In the Gan layer, the symbols set ‘ [symbol] ’ [symbol] corresponds to the pattern name ‘combination’. Rule: The Serving Wuxing are ‘earth’ and ‘metal’ respectively. Operation: First connect within the same layer [56d][56e], then map to the corresponding Wuxing layer through [56c].

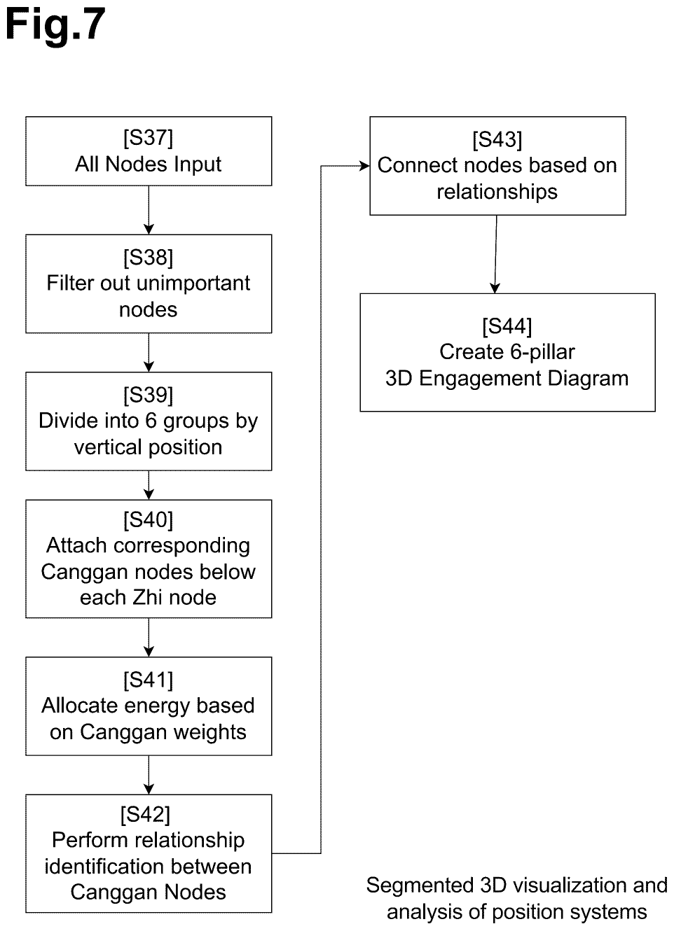

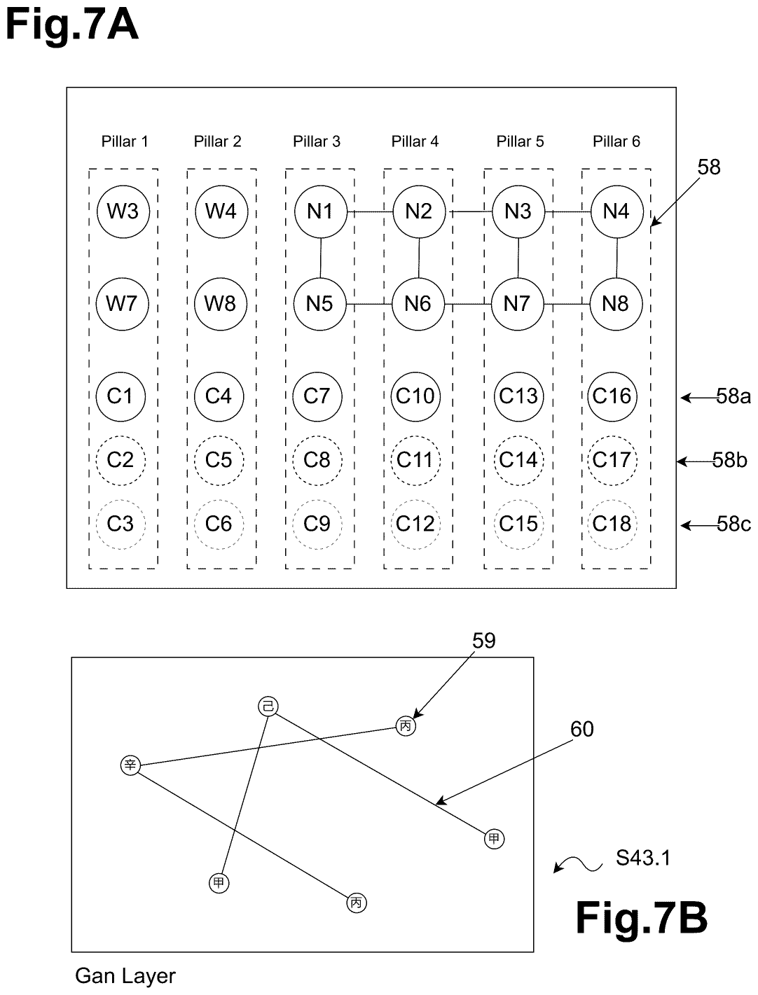

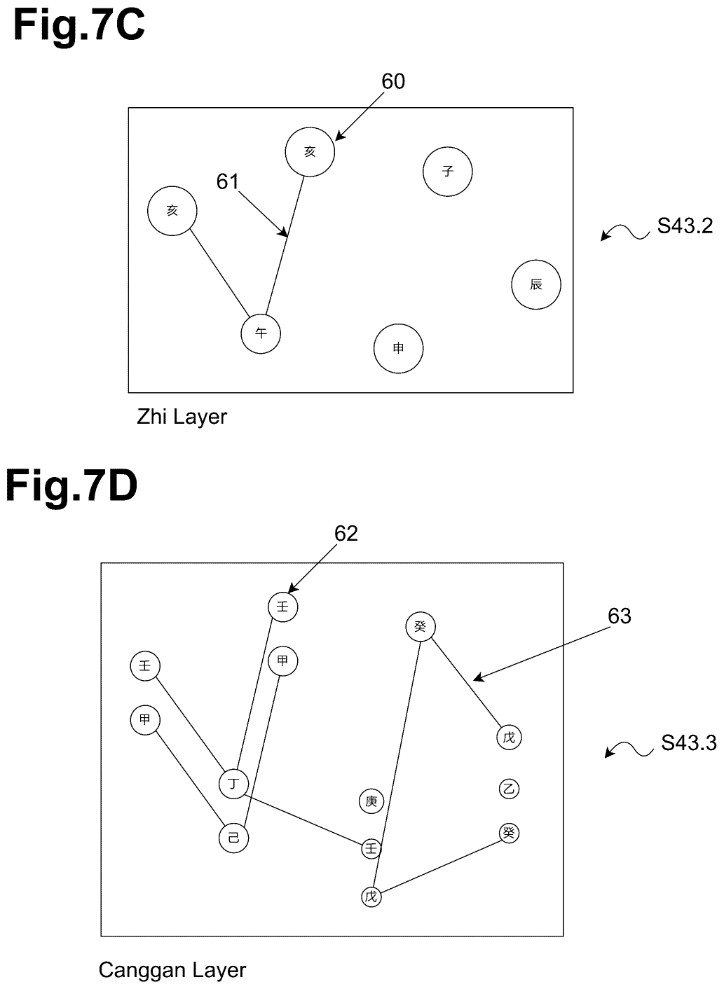

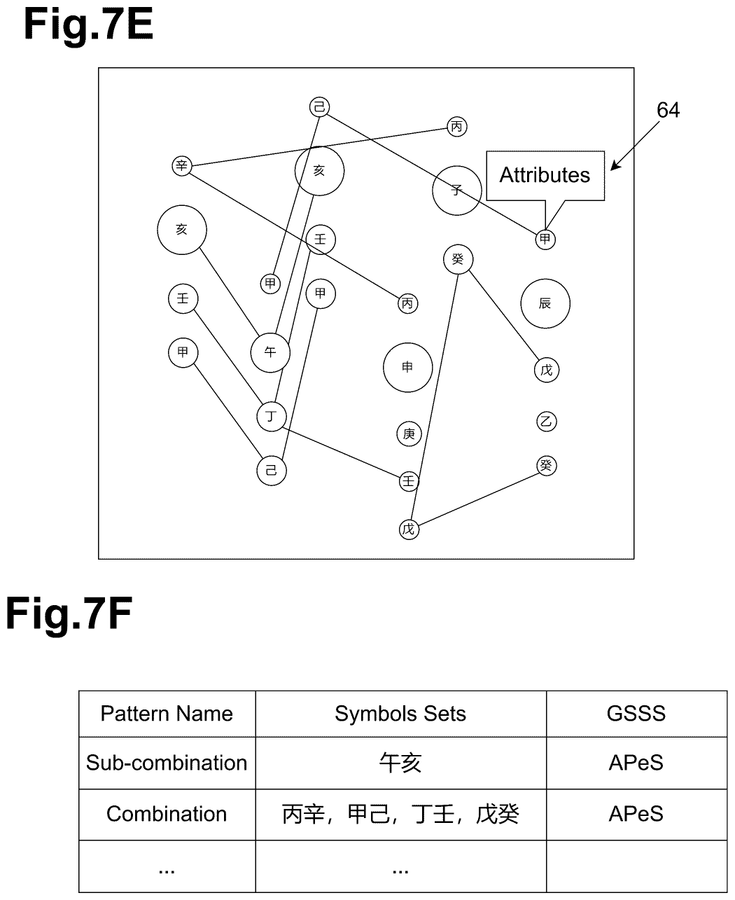

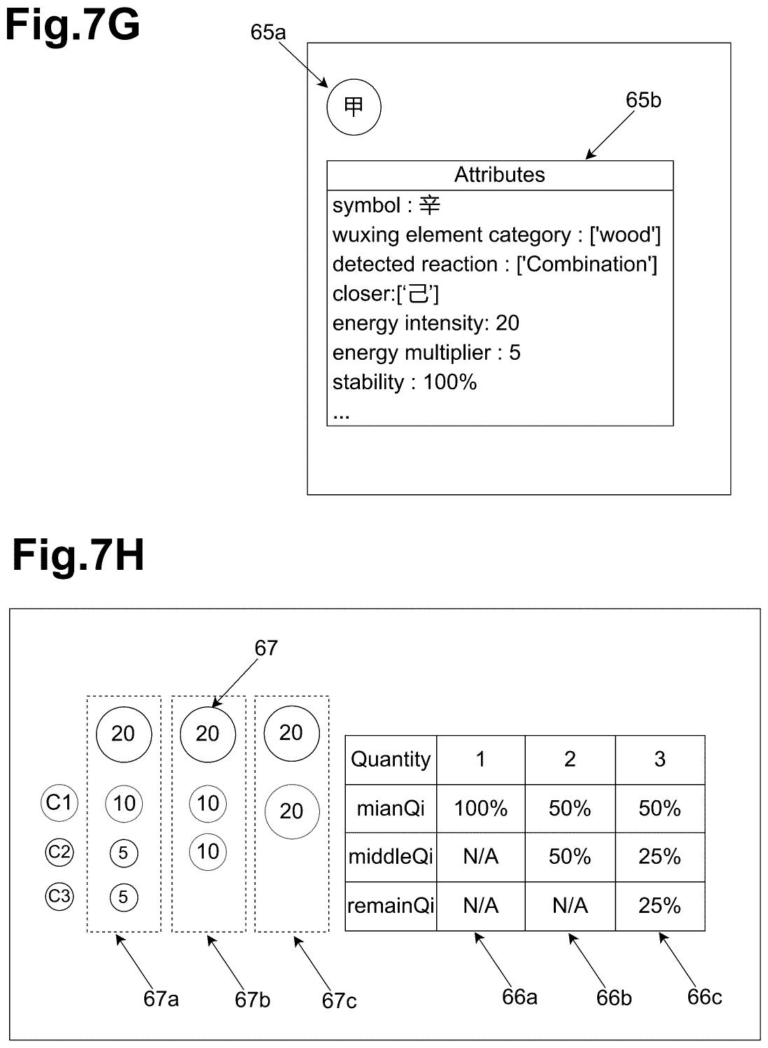

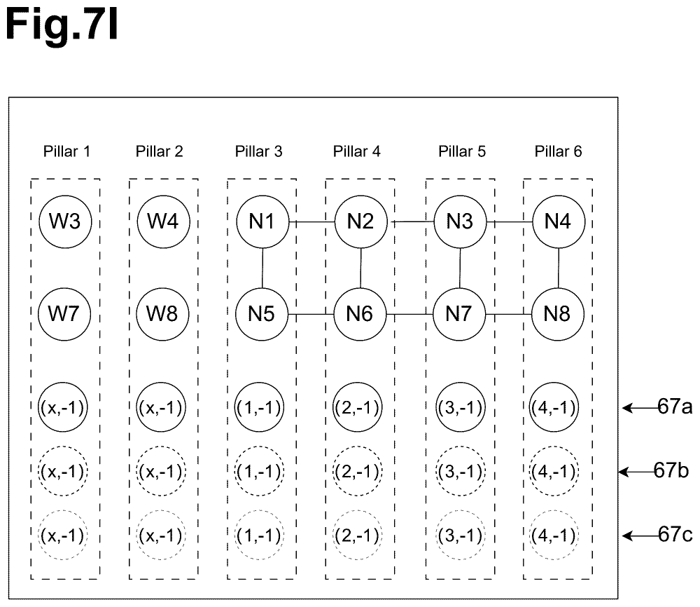

FIG. 7 describes a quantitative data visualization method that preserves node position attributes. This method provides a multi-dimensional energy analysis view while maintaining the original spatial structure. The specific steps are as follows:
[S37] Data input: Input all nodes, for example, 16 nodes in [47].
[S38] Node filtering: Filter out unimportant nodes (W1, W2, W5, W6). [48] shows the node structure after filtering.
[S39] Node classification:
Horizontal direction: Divided into 6 pillars [58]
Vertical direction: Divided into 3 layers (Gan layer, Zhi layer, Canggan layer)
FIG. 7B: Gan layer (Heavenly Stems layer)
FIG. 7C: Zhi layer (Earthly Branches layer)
[S40] CangGan node generation: Generate CangGan nodes (Hidden Stems nodes) for all Zhi nodes based on the content in FIG. 2A. FIG. 7D shows the CangGan layer.

It is important to note a key aspect of the CangGan (Hidden Stem) nodes' representation in the system. While FIG. 7 I visually depicts the CangGan nodes (C1-C18) in a hierarchical arrangement for clarity of illustration, in the actual computational model and data structure of the system, all CangGan nodes share the same Y-coordinate. This means that in the positioning system, they are aligned on the same horizontal plane. This arrangement serves multiple purposes: it simplifies calculations related to energy flow and pattern recognition, optimizes data storage and retrieval processes, and maintains a consistent logical structure in the system. The shared Y-coordinate of CangGan nodes reflects their unique role in the Gan-Zhi system as implicit elements within the Earthly Branches, distinct from the explicit Heavenly Stems and Earthly Branches. This design choice enhances the system's efficiency in processing complex Gan-Zhi relationships while preserving the traditional conceptual framework of Chinese metaphysics.
[S41] CangGan energy distribution: Distribute CangGan energy weights based on the settings in FIG. 7H. Example (node [67], energy intensity is 20):

$$1 hidden stem : c 1 ( mainQi ) = 20$$

$$2 hidden stems : c 1 ( mainQi ) = 10 , c 2 ( middleQi ) = 10$$

$$3 hidden stems : c 1 ( mainQi ) = 10 , c 2 ( middleQi ) = 5 , c 3 ( remainQi ) = 5$$

[S42] CangGan Nodes pattern recognition: Perform pattern recognition on CangGan Nodes and generate connection lines.
[S43] Pattern recognition and connection line generation:
[S43.1] Gan Nodes processing:
Based on [49] data in FIG. 6B
Generate Gan Nodes (W3, W4, N1, N2, N3, N4) [59]
Perform pattern recognition and generate connection lines [60]
[S43.2] Zhi Nodes processing:
Generate Zhi Nodes (W7, W8, N5, N6, N7, N8) [60]
Perform pattern recognition and generate connection lines [61]
Use the selector specified in the GSSS column of FIG. 7F, combined with the recognizer in FIG. 4B for pattern recognition
[S43] Relationship line generation: Generate relationship lines based on recognition results.
[S44] Visualization: Generate a 6-pillar 3D Engagement Diagram.

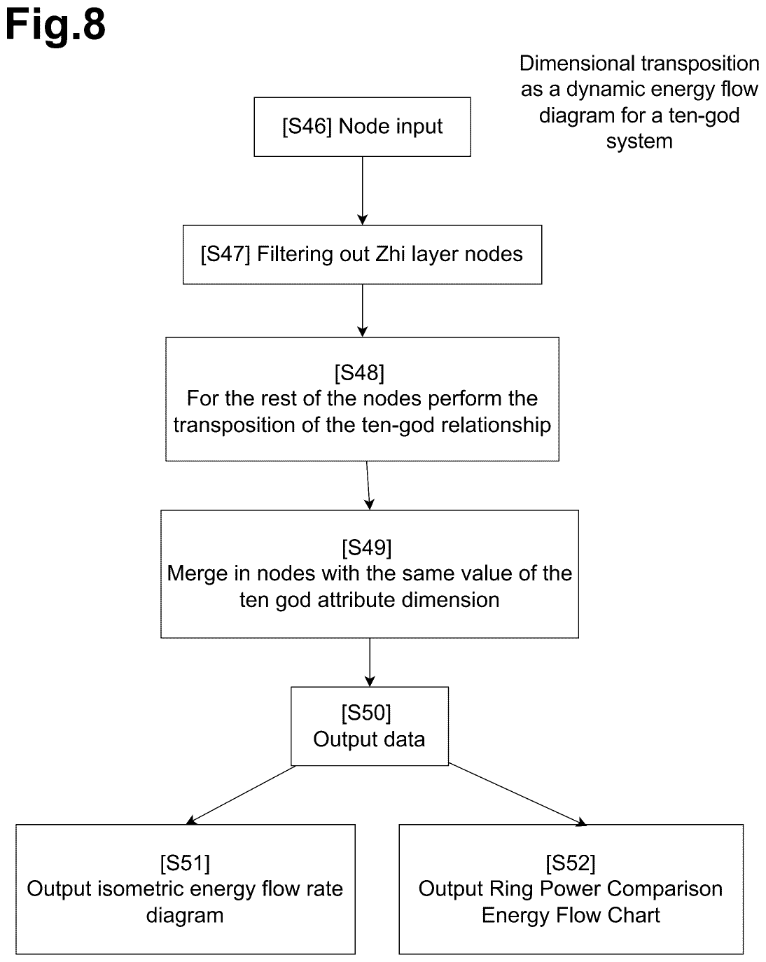

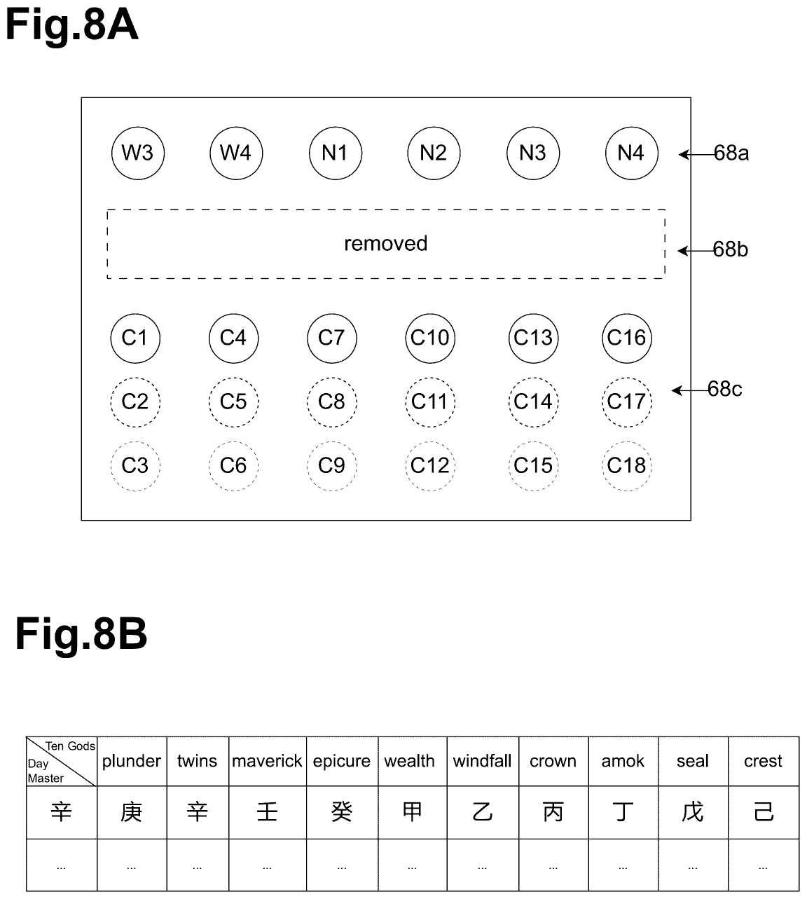

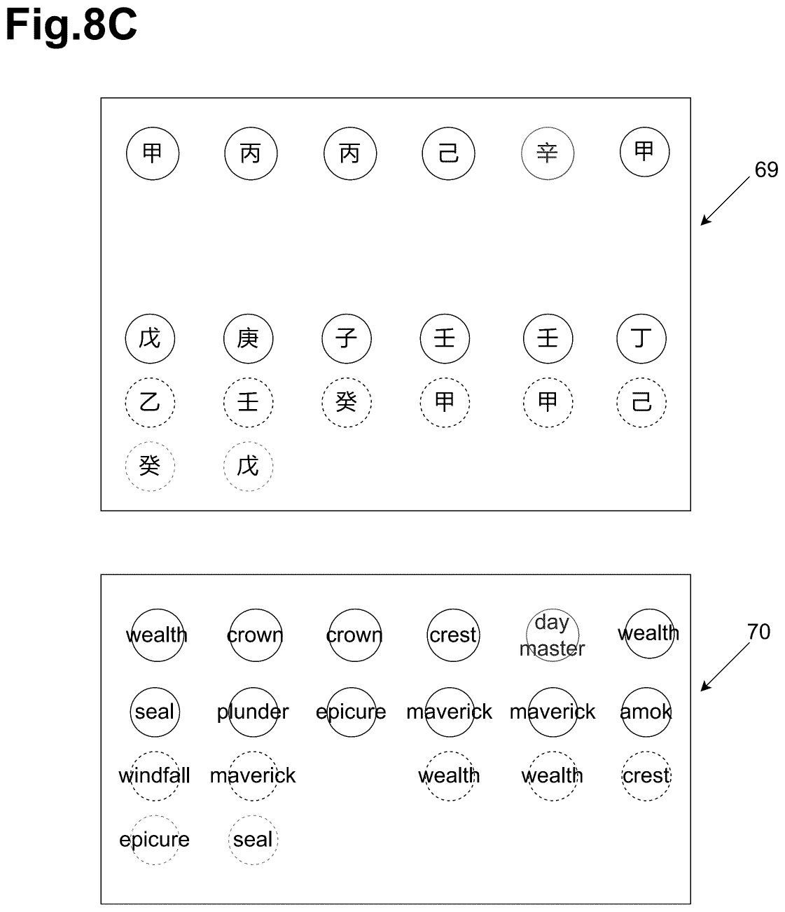

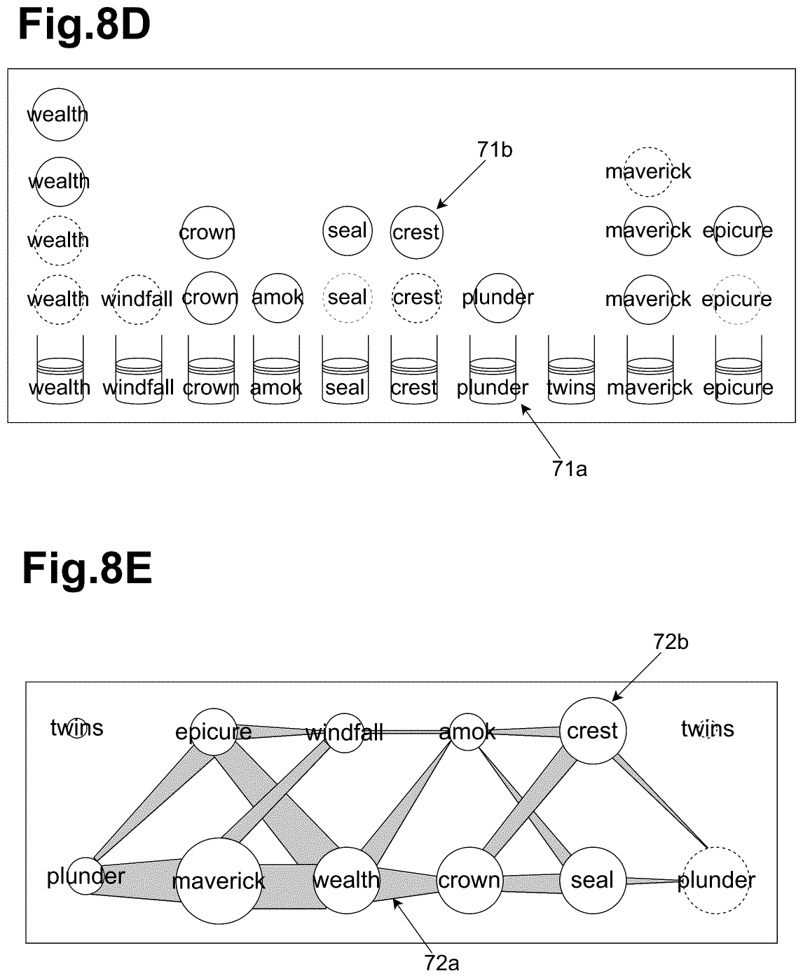

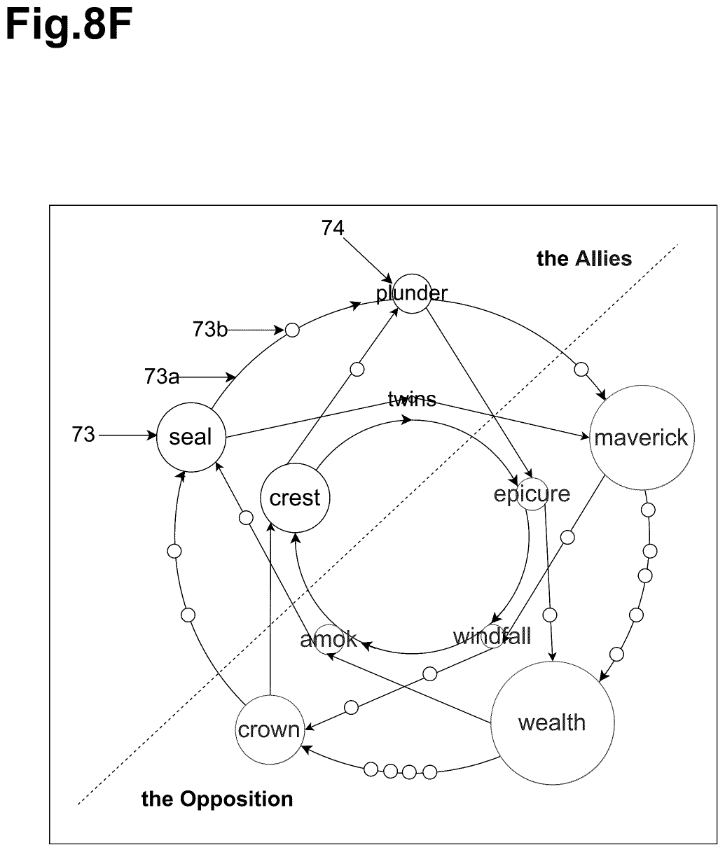

FIG. 8 shows two methods of transposing analysis data into the Ten Gods system and visualizing it.
[S46] Input the filtered node data from [S38].
[S47] Remove all nodes from the Zhi layer (Earthly Branches layer), as the Ten Gods system revolves only around Gan elements (Heavenly Stems). Retain the hidden stem nodes (C1-C18) [68c] and Gan nodes (N1-N4, W3-W4) [68a]. Figure [69] shows an example after node removal.
[S48] Transpose the remaining nodes according to the rules defined in FIG. 8B. [70] shows a completed transposition case. The Ten Gods system represents the relationship of each node relative to the Day Master (i.e., the Day Stem).
[S49] Merge nodes with the same Ten Gods attribute, accumulating their energy intensity. For example, merge the two identical nodes in [71b].
[S50] Output the data results.
[S51] Create an equidistant energy flow diagram (FIG. 8E). The size of nodes is determined by energy intensity [72b], and the degree of energy flow between nodes is represented by ribbons [72a].
[S52] Generate a circular dynamic energy flow diagram (FIG. 8F). The size of nodes is determined by energy intensity. This diagram uses animation effects to visualize energy flow, specifically represented by small balls sent between nodes. Parameters such as the number, size, and movement speed of the balls can be adjusted according to specific algorithms. These parameters are related to the energy relationship between nodes, but the specific association method can be customized according to requirements.

Case explanation: Following the arrow direction, node [73] sends energy balls [73b] along the specified path [73a] to the next node [74]. The visualization parameters of energy flow (such as the number and speed of balls) can be dynamically adjusted according to the selected algorithm to best demonstrate the energy relationship between nodes. The dividing lines in the diagram are used to distinguish opposing forces.

### VI. SCOPE OF APPLICATION

The present invention has a wide range of applications, including but not limited to the following fields:
Traditional Metaphysical Analysis: Case study: A metaphysical analyst uses this system to analyze a client's fortune for the coming year. The system converts the client's birth data and dates for the coming year into Gan-Zhi representation, identifying specific energy patterns. For example, it may recognize a “Triple Combination” pattern, marking it with specific color connections in the Six Pillars diagram. The analyst can quickly locate key periods and provide precise advice, such as predicting increased financial luck.
Historical Event Analysis: Case study: Historians utilize the system to analyze patterns in Chinese dynastic changes throughout history. The system batch processes historical dates, converting them to Gan-Zhi representation and displaying them on a timeline. Using graph theory algorithms, it identifies specific energy patterns before and after dynastic changes, such as “Three Punishments”. This pattern recognition helps uncover overlooked historical regularities, providing new dimensions for research.
Economic Cycle Research: Case study: Economists analyze 50 years of economic data. The system converts key indicator release dates to Gan-Zhi representation, adjusting energy intensity visualization based on indicator values. For instance, when economic growth is high, the corresponding Gan-Zhi symbols are displayed as larger nodes. Through dynamic energy flow diagrams, potential correlations between economic cycles and Gan-Zhi combinations can be intuitively observed, aiding economic forecasting.
Natural Phenomena Research: Case study: Meteorologists study the correlation between extreme weather events of the past century and Gan-Zhi cycles. The system converts weather data into Gan-Zhi representation, identifying specific energy patterns through graph theory models. This helps discover potential relationships between weather patterns and Gan-Zhi cycles, providing new perspectives for long-term weather prediction.
Personal Development Analysis: Case study: Career counselors conduct career planning for clients. Through the Ten Gods dynamic energy flow diagram, the client's talents and strengths can be intuitively visualized. For example, strong “Wealth” and “Resource” energies might indicate suitability for a technical career path. This visual analysis aids in more precise career development planning.
Organizational Management: Case study: Corporate strategy consultants analyze key decision-making timepoints for companies. The system converts important company dates into Gan-Zhi representation, marking them in the Six Pillars diagram. Through pattern recognition algorithms, it identifies energy patterns present during successful product launches. This helps in selecting optimal timing for future product releases, increasing the success rate of new products.

By converting characteristic times of various events into the 60 Jiazi chronology, this invention provides an innovative method for studying cyclical changes and energy flows. It combines traditional metaphysical wisdom with modern computer science and graph theory, offering an innovative analytical tool for multi-domain research and decision-making.

### APPENDIX A: GRAPH-BASED PATTERN RECOGNITION ALGORITHM

### Introduction

The Graph-based Pattern Recognition Algorithm is a core component of our invention, designed to identify and analyze complex patterns within Gan-Zhi energy systems. By leveraging graph theory, this algorithm transforms traditional Chinese metaphysical concepts into a quantifiable and computationally analyzable form.

### Key Features

1. Graph Representation: Represents Gan-Zhi relationships as a graph structure, enabling the application of advanced graph theory algorithms.
2. Multiple Search Strategies: Implements various search algorithms to identify different types of patterns and relationships.
3. Flexible Pattern Matching: Allows for the definition and recognition of complex patterns within the Gan-Zhi system.

### Algorithm Components

The algorithm consists of five specialized searchers:
1. Linear Triad Searcher (LTS)
2. Adjacent Pair Searcher (APS)
3. Arbitrary Triad Searcher (ATS)
4. Arbitrary Pair Searcher (APeS)
5. Dual-Row Pattern Matcher (DRPM)

### Pseudocode

1. Linear Triad Searcher (LTS)
   Input: Graph G, Pattern P, Maximum Distance D
   Output: Set R of node components matching the pattern
Algorithm LTS(G, P, D):

```
1. Initialize an empty result set R
2. For each node N in graph G:
  If N is unvisited and available:
    C = BreadthFirstSearch(G, N, P, D)
    If C is a valid component:
      Add C to R
3. Return R
```

2. Adjacent Pair Searcher (APS)
   Input: Graph G, Pattern P, Maximum Distance D (default is 1)
   Output: Set R of node pairs matching the pattern
   Algorithm APS(G, P, D):

```
1. Initialize an empty result set R
2. For each node N in graph G:
  If N is unvisited and available:
    For each neighbor M of N within distance D:
      If M is unvisited and available:
        If [N, M] is a valid pair:
          Add [N, M] to R
          Mark N and M as visited
3. Return R
```

3. Arbitrary Triad Searcher (ATS)
   Input: Graph G, Pattern P
   Output: Set R of node triads matching the pattern
   Algorithm ATS(G, P):

```
1. Initialize an empty result set R
2. For each node N1 in graph G:
  For each node N2 in graph G (N2 ≠ N1):
    For each node N3 in graph G (N3 ≠ N1, N3 ≠ N2):
      If [N1, N2, N3] is a valid triad:
        Add [N1, N2, N3] to R
3. Return R
```

4. Arbitrary Pair Searcher (APeS)
   Input: Graph G, Pattern P
   Output: Set R of node pairs matching the pattern
   Algorithm APeS(G, P):

```
1. Initialize an empty result set R
2. For each node N1 in graph G:
  For each node N2 in graph G (N2 ≠ N1):
    If [N1, N2] is a valid pair and not visited:
      Add [N1, N2] to R
      Mark [N1, N2] as visited
3. Return R
```

5. Dual-Row Pattern Matcher (DRPM)
   Input: Graph G, Pattern P
   Output: Set R of vertically adjacent node pairs matching the pattern
   Algorithm DRPM(G, P):

```
1. Initialize an empty result set R
2. For each lower node L in graph G:
  U = upper adjacent node of L
  If U exists and [L, U] is a valid pair:
    Add [L, U] to R
3. Return R
```

Auxiliary Functions:
IsValidPair(node pair, pattern)
IsValidTriad(node triad, pattern)
IsValidComponent(node component, pattern)
IsNodeAvailable(node)
BreadthFirstSearch(graph, start node, pattern, maximum distance)

### APPENDIX B: PRIORITY CUSTOMIZATION AND PARALLEL COMPUTATION CONFLICT RESOLUTION ALGORITHM

### Introduction

The Priority Customization and Parallel Computation Conflict Resolution Algorithm is designed to optimize the processing of multiple analytical modules in Gan-Zhi energy analysis systems. It ensures efficient utilization of computational resources while maintaining the integrity and accuracy of the analysis.

### Key Features

1. Dynamic Priority System: Allows for customizable priority assignment to different analytical modules.
2. Parallel Processing Capability: Enables concurrent execution of compatible modules.
3. Conflict Resolution Mechanism: Handles potential data conflicts arising from parallel processing.
4. Flexible Data Merging: Intelligently combines results from different modules.

### Algorithm Structure

The algorithm follows a structured approach:
1. Initialization
2. Main Processing Loop
3. Parallel Execution
4. Result Merging
5. Conflict Resolution

### Pseudocode

### Algorithm: Priority Customization and Parallel Computation Conflict Resolution

### Input:

Position dataset P
Set of modules M
Priority settings Priority
Parallel group settings ParallelGroups

### Output:

Updated position dataset P′

```
// Initialization
1. Sort Priority in ascending order of priority value
2. Initialize result set P′ = deep copy of P
// Main loop
3. For each priority level in Priority:
  3.1 Get all modules CurrentModules at current priority level
  3.2 Initialize level results LevelResults = empty list
  3.3 For each module in CurrentModules:
    3.3.1 If module is in ParallelGroups:
      Process in parallel:
      a. Create thread/process to execute module(P′)
      b. Add result to LevelResults
    3.3.2 Else:
      Process sequentially:
      a. Execute module(P′)
      b. Add result to LevelResults
  3.4 Wait for all parallel tasks to complete
  3.5 Merge results:
    For each result in LevelResults:
      For each position in P′:
        If position is available AND result affects position:
          Update attributes of P′[position]
          Mark P′[position] as occupied
4. Return P′
```

Function IsPositionAvailable(position, module):

```
  If position is not occupied:
    Return true
  Else:
    occupiedBy = module occupying the position
    If Priority[module] < Priority[occupiedBy]:
      Return false
    Else if Priority[module] == Priority[occupiedBy] AND module is
not in same ParallelGroup as occupiedBy:
      Return false
    Else:
      Return true
```

Function MergePositionData(position, newData):

```
  // Merge events, contributing wuxing, foes, closer, etc.
  position.events = MergeLists(position.events, newData.events)
  position.contributingWuxing =
MergeLists(position.contributingWuxing, newData.contributingWuxing)
  position.foes = MergeLists(position.foes, newData.foes)
  position.closer = MergeLists(position.closer, newData.closer)
  // Update stability (take the lower value)
  position.stability = min(position.stability, newData.stability)
  // Update energy (take the higher value)
  If newData.energy > position.energy:
    position.energy = newData.energy
    position.energyAdjustmentFactor = newData.energyAdjustmentFactor
  // Preserve original attributes
  Preserve(position.name, position.wuxing, position.yinyang,
  position.position)
Function MergeLists(list1, list2):
  Return Deduplicate(list1 + list2)
```

### Innovation and Application

The algorithm's innovation lies in its ability to:
1. Manage complex, interdependent analyses in parallel.
2. Respect a customizable priority system.
3. Efficiently resolve conflicts in multi-module processing.
4. Adapt to various metaphysical analysis scenarios.

This algorithm significantly enhances the efficiency and flexibility of Gan-Zhi energy analysis systems, bridging traditional metaphysics with modern computational techniques.

### APPENDIX C: GLOSSARY FOR GAN-ZHI ENERGY QUANTIFICATION AND VISUALIZATION SYSTEM

Gan (Heavenly Stems): Ten basic symbols in traditional Chinese calendar, representing single energy attributes.

Zhi (Earthly Branches): Twelve symbols in traditional Chinese calendar, each composed of 1-3 Heavenly Stems (Hidden Stems).

Gan-Zhi System: Traditional Chinese time encoding method, composed of combinations of Heavenly Stems (Gan) and Earthly Branches (Zhi). This system is the foundation of ancient Chinese calendar and metaphysics.

CangGan (Hidden Stems): Heavenly Stem elements implicit in Earthly Branches, usually 1-3 per Earthly Branch.

Day Master: In Eight Characters, represents the natal Day Stem, the core reference point for analysis. The Day Master is the Gan element content at the Day Gan position.

Sixty Jiazi Chronology(Chinese Sexagenary cycle): Traditional Chinese time calculation method, composed of Heavenly Stems and Earthly Branches, totaling 60 combinations forming a cycle.

Pattern Recognition: In this system, refers to the process of identifying specific Gan-Zhi combinations and their represented energy patterns.

GSSS: Graph Structure Search Suite

Energy Intensity: In this system, calculated by multiplying base energy by energy multiplier, used to quantify the energy magnitude of Gan-Zhi relationships.

Ten Gods System: A relative system based on the Day Master, describing the relationship of other Heavenly Stems to the Day Master, including Printing, Hurting, Officer, Wealth, Resource, and Peer.

Five Elements: Five basic elements in traditional Chinese philosophy (Metal, Wood, Water, Fire, Earth), used to describe natural change patterns.

Flow: Represents energy changes over shorter time periods (usually year, month, day).

Yun (Big foretune/luck pillar): A Gan-Zhi combination representing the fortune indicator for each decade of a person's life, calculated based on the individual's birth date and Day Master according to traditional methods. It represents energy changes over longer time periods, typically spanning 10 years each.

Node: Basic unit representing Gan-Zhi elements in the graph theory model.

Wildcard Position: Special nodes in the position system that can match any position.

Searcher: Algorithmic tools used to identify specific patterns in the graph theory model, including LTS, APS, ATS, APeS, and DRPM.

Six Pillars System: A complete analysis framework including Four Pillars (year, month, day, hour), Yun Pillar (10 years), and Flow Year(1 year).

### APPENDIX D: GAN-ZHI SYSTEM REFERENCE TABLES

### 1. Introduction

This appendix provides detailed reference tables for the Gan-Zhi system, including Heavenly Stems (Tiangan), Earthly Branches (Dizhi), and Hidden Stems in Earthly Branches (Canggan). These tables are essential for understanding the basic elements and their attributes in the Gan-Zhi energy quantification and visualization system.

### 2. Heavenly Stems (Tiangan)

TABLE D.1
Heavenly Stems (Tiangan) Attributes

| Symbol | Pinyin | English | Wuxing |
|---|---|---|---|
| [symbol] | Jiǎ | Jia | Wood |
| [symbol] | Yǐ | Yi | Wood |
| [symbol] | Bǐng | Bing | Fire |
| [symbol] | Dīng | Ding | Fire |
| [symbol] | Wù | Wu | Earth |
| [symbol] | Jǐ | Ji | Earth |
| [symbol] | Gēng | Geng | Metal |
| [symbol] | Xīn | Xin | Metal |
| [symbol] | Rén | Ren | Water |
| [symbol] | Guǐ | Gui | Water |

### 3. Earthly Branches (Dizhi)

TABLE D.2
Earthly Branches (Dizhi) Attributes

| Symbol | Pinyin | English | Wuxing |
|---|---|---|---|
| [symbol] | Zǐ | Zi | Water |
| [symbol] | Chǒu | Chou | Earth |
| [symbol] | Yín | Yin | Wood |
| [symbol] | Mǎo | Mao | Wood |
| [symbol] | Chén | Chen | Earth |
| [symbol] | Sì | Si | Fire |
| [symbol] | Wǔ | Wu | Fire |
| [symbol] | Wèi | Wei | Earth |
| [symbol] | Shēn | Shen | Metal |
| [symbol] | Yǒu | You | Metal |
| [symbol] | Xū | Xu | Earth |
| [symbol] | Hài | Hai | Water |

### 4. Hidden Stems in Earthly Branches (Canggan)

TABLE D.3
Hidden Stems in Earthly Branches (Canggan)

| Symbol | Main Qi (C1) | Middle Qi (C2) | Remain Qi (C3) |
|---|---|---|---|
| [symbol] Zi | [symbol] Gui | | |
| [symbol] Chou | [symbol] Ji | [symbol] Gui | [symbol] Xin |
| [symbol] Yin | [symbol] Jia | [symbol] Bing | [symbol] Wu |
| [symbol] Mao | [symbol] Yi | | |
| [symbol] Chen | [symbol] Wu | [symbol] Yi | [symbol] Gui |
| [symbol] Si | [symbol] Bing | [symbol] Wu | [symbol] Geng |
| [symbol] Wu | [symbol] Ding | [symbol] Ji | |
| [symbol] Wei | [symbol] Ji | [symbol] Ding | [symbol] Yi |
| [symbol] Shen | [symbol] Geng | [symbol] Ren | [symbol] Wu |
| [symbol] You | [symbol] Xin | | |
| [symbol] Xu | [symbol] Wu | [symbol] Xin | [symbol] Ding |
| [symbol] Hai | [symbol] Ren | [symbol] Jia | |

1. A system for quantifying and visualizing Gan-Zhi energy based on graph theory, comprising:
a time conversion module conFigured to convert input time into a standardized Gan-Zhi representation, including year Gan-Zhi, month Gan-Zhi, day Gan-Zhi, and hour Gan-Zhi;
a graph theory model construction module conFigured to construct a complex network graph model based on the converted Gan-Zhi data, wherein nodes represent Gan-Zhi elements and edges represent Gan-Zhi relationships;
an energy quantification module conFigured to quantify energy for each node and relationship in the graph model using predefined energy models, including calculating energy intensity and stability;
a pattern recognition module conFigured to identify specific energy patterns in the graph model using multiple search algorithms;
a data analysis module conFigured to perform in-depth data analysis based on the identified patterns, including energy flow; and
a result visualization module conFigured to present the analysis results using multi-dimensional visualization techniques, including Five Elements mapping diagram, Six Pillars interaction diagram, and Ten Gods system dynamic diagram.

2. The system of claim 1, wherein the pattern recognition module includes:
a Linear Triad Searcher (LTS) conFigured to search for combinations of three elements within a limited horizontal distance;
an Adjacent Pair Searcher (APS) conFigured to search for combinations of two elements within a limited horizontal distance;
an Arbitrary Triad Searcher (ATS) conFigured to search for combinations of three elements without distance limitation;
an Arbitrary Pair Searcher (APeS) conFigured to search for combinations of two elements without distance limitation; and
a Dual-Row Pattern Matcher (DRPM) conFigured to perform searches in vertical positions;
wherein each searcher uses specific graph traversal algorithms and pattern matching rules.

3. The system of claim 1, wherein the graph theory model construction module uses an adjacency list data structure to represent the graph, and includes:
a node generation unit conFigured to convert Gan-Zhi elements into graph nodes;
an edge generation unit conFigured to generate edges between nodes based on predefined Gan-Zhi relationship rules;
an attribute assignment unit conFigured to assign initial attribute values to each node.

4. The system of claim 1, wherein the energy quantification module uses a customizable energy model with pre-set parameters, allowing users to define:
base energy values for different types of Gan-Zhi elements;
stability calculation rules for various Gan-Zhi combinations;
energy intensity calculation formulas that incorporate both base energy and position-specific multipliers; and
additional energy attributes relevant to specific analysis requirements; wherein these pre-set parameters can be adjusted to accommodate different schools of thought or analysis objectives within traditional Chinese metaphysics.

5. The system of claim 1, further comprising a priority setting and parallel computing module conFigured to:
set priorities for pattern recognition;
implement parallel computing within the same priority level; and
handle conflicts between different priority levels using a conflict resolution mechanism, wherein the conflict resolution mechanism includes: (a) for detected reactions, combining all identified patterns in an array; (b) for stability values, selecting the minimum value among conflicting patterns; (c) for energy multiplier values, selecting the maximum value among conflicting patterns; and (d) for other numeric attributes, applying user-defined rules to select either the maximum, minimum, or average value of conflicting data.

6. The system of claim 1, wherein the result visualization module includes a Gan-Zhi to Five Elements mapping visualization unit conFigured to:
filter and merge nodes based on their Gan-Zhi attributes;
initialize a Five Elements visualization layer;
define mapping rules from Gan-Zhi symbols to Five Elements; and
perform relationship mapping and visual display according to the defined rules.

7. The system of claim 1, wherein the result visualization module includes a Six Pillars interaction diagram visualization unit conFigured to:
classify nodes into Gan(Heavenly Stems) layer, Zhi(Earthly Branches) layer, and Canggan(Hidden Stems) layer;
generate Canggan(Hidden Stems) nodes and allocate energy based on predefined distribution rules;
perform pattern recognition within each layer and generate connections; and
generate a three-dimensional interactive Six Pillars diagram.

8. The system of claim 1, wherein the result visualization module includes a Ten Gods system animation visualization unit conFigured to:
transpose Gan-Zhi data into the Ten Gods system based on the Day Master;
create an equidistant energy flow diagram where node sizes are determined by energy intensity; and
generate a circular energy flow dynamic diagram that demonstrates energy flow between nodes through animation effects, with customizable parameters for flow visualization.

9. A method for analyzing Gan-Zhi energy using the system of claim 1, comprising:
inputting a characteristic time point of the analysis subject;
converting the input time to a standardized Gan-Zhi representation, including year Gan-Zhi, month Gan-Zhi, day Gan-Zhi, and hour Gan-Zhi;
constructing a complex network graph model based on the converted Gan-Zhi data;
quantifying energy for each node and relationship in the graph model using predefined energy models;
identifying specific energy patterns in the graph model using multiple search algorithms;
performing in-depth data analysis based on the identified patterns, including energy flow; and
presenting the analysis results using multi-dimensional visualization techniques, including generating Five Elements mapping diagram, Six Pillars interaction diagram, and Ten Gods system dynamic diagram.

10. A computer-readable storage medium storing a computer program, wherein the program, when executed by a processor, implements the Gan-Zhi energy analysis method of claim 9.

11. A Gan-Zhi energy analysis apparatus, comprising:
a processor;
a memory coupled to the processor;
a display device;
an input device; and
a non-transitory computer-readable storage medium storing program instructions that, when executed by the processor, cause the apparatus to: (a) receive, via the input device, a characteristic time point for analysis; (b) convert the input time to a standardized Gan-Zhi representation; (c) construct a graph model based on the Gan-Zhi data; (d) quantify energy attributes for elements in the graph model; (e) identify energy patterns using multiple search algorithms; (f) perform data analysis based on the identified patterns; and (g) display, on the display device, analysis results using multi-dimensional visualization techniques, including Five Elements mapping, Six Pillars interaction, and Ten Gods system dynamic diagrams; wherein the apparatus implements the system of claim 1 and provides a user interface for customizing analysis parameters and viewing results.
